(19) United States
(12) Patent Application Publication
(10) Pub. No.: US 2025/0329318 A1
(43) Pub. Date: Oct. 23, 2025

(54) Electronic Percussion Instrument

(71) Applicant: Ef-Note Inc., Hamamatsu-shi (JP)

(72) Inventors: Tatsuya KOMORI, Hamamatsu-shi (JP); Yoshiaki MORI, Hamamatsu-shi (JP)

(21) Appl. No.: 19/215,714

(22) Filed: May 22, 2025

Related U.S. Application Data
(63) Continuation of application No. PCT/JP2023/042207, filed on Nov. 24, 2023.

(30) Foreign Application Priority Data
Nov. 28, 2022 (JP) 2022-189678

(51) Int. Cl. G10H 3/14; G10D 13/02; G10D 13/063; G10D 13/10; G10H 1/00

(52) U.S. Cl. CPC G10H 3/146; G10D 13/02; G10D 13/063; G10D 13/26; G10H 1/0008; G10H 2230/281; G10H 2230/321

(57) ABSTRACT

An electronic percussion instrument has a plurality of hit positions, and a sound source part 10 that includes: a hit position identification part 12 identifying one of the hit positions which has been hit, based on a detection signal output from a hit detection part; a threshold value setting part 13 sets a threshold value according to the hit position identified by the hit position identification part 12; and a musical sound production part 14 produces and outputs a predetermined musical sound based on a detection signal that has exceeded the threshold value set by the threshold value setting part 13. The threshold value set by the threshold value setting part 13 forms a gradual decrease line that gradually decreases with a lapse of time, and the gradual decrease line is set individually for the hit position identified by the hit position identification part 12.

### CROSS-REFERENCE TO RELATED APPLICATIONS

This application is a continuation of International Application PCT/JP2023/042207, filed Nov. 24, 2023, which claims priority to Japanese Application No. 2022-189678, filed Nov. 28, 2022. The disclosures of the above applications are incorporating herein by reference.

### FIELD

The present disclosure relates to an electronic percussion instrument that produces and outputs a predetermined music sound based on a detection signal generated by a hit.

### BACKGROUND

This section provides background information related to the present disclosure which is not necessarily prior art.

An electronic cymbal as an electronic percussion instrument normally includes: an electronic cymbal body having a hitting surface that a player can hit; a vibration sensor that can detect a hit on the hitting surface; and a sound source part that produces and outputs a predetermined musical sound based on a detection signal detected by the vibration sensor. When a player hits the hitting surface of the electronic cymbal body with a stick, the vibration sensor detects the hit, external output from the sound source part can be performed, and similar performances to acoustic cymbal performances can thereby be achieved.

However, for example, Japanese examined Patent Application Publication No. H7-69687 discloses an electronic musical instrument that stores maximum values of the amount of vibration caused by hitting, generates a reference value corresponding to a virtual quasi-envelope curve similar to an envelope curve of actual vibration based on the maximum values, and produces a musical sound by comparing the amount of vibration with the reference value. With this related art, a reference for determining excitation can be set in any manner, thus it is possible to reliably determine excitation and output an appropriate musical sound.

### SUMMARY

However, the related art described above has the following problem.

In an electronic percussion instrument such as an electronic cymbal, multiple hit positions are set, such as a bow part, an edge part, and a cup part, and vibration characteristics vary with the hit positions to be hit. Thus, for example, when a player hits the edge part with a stick, gentle vibration continues for a relatively long time, whereas, when a player hits the cup part, short vibration with a sharp rise occurs. Normally, an edge part and a cup part are hit with a shoulder part (middle of a stick) of a stick, whereas a bow part is hit with the tip part (distal end) of a stick, thus vibration caused by hitting is relatively small and short.

In this manner, in an electronic percussion instrument in the related art, regardless of variation in vibration characteristics according to the hit position to be hit, a threshold value (the reference value corresponding to the virtual quasi-envelope curve in Japanese examined Patent Application Publication No. H7-69687) for erroneous sound production prevention process is set uniformly without consideration of the difference in the vibration characteristics. Thus, for example, when multiple hit positions are consecutively hit, a problem may arise in a performance, for instance, a musical sound may not be produced. Such a problem arises not only in an electronic cymbal, but also in an electronic musical instrument having a plurality of hit positions in general. The present applicant has intensively studied this to eliminate the problem.

The present disclosure has been made in consideration of the above-described situation, and it is an object of the present disclosure to provide an electronic percussion instrument that can set a threshold value in consideration of the vibration characteristics at each of the hit positions, and even with the hit positions consecutively hit, can reliably produce and output a musical sound according to each hit.

According to the disclosure, an electronic percussion instrument comprises: a body having a plurality of hit positions allowed to be hit by a player; a hit detection part that is mounted on the body and detects a hit at the hit positions and outputs a predetermined detection signal; and a sound source part that produces and outputs a predetermined musical sound based on the detection signal output from the hit detection part. The sound source part includes: a hit position identification part that identifies the hit position that has been hit based on the detection signal output from the hit detection part; a threshold value setting part that sets a threshold value according to the hit position identified by the hit position identification part; and a musical sound production part that produces and outputs a predetermined musical sound based on the detection signal that has exceeded the threshold value set by the threshold value setting part. The threshold value set by the threshold value setting part forms a gradual decrease line which gradually decreases with a lapse of time. The gradual decrease line is set individually for each hit position identified by the hit position identification part.

According to the disclosure, where the electronic percussion instrument sound source part is configured to, after the detection signal output from the hit detection part exceeds a minimum of the threshold value, produce a musical sound corresponding to a maximum of the detection signal output in an interval until a predetermined time period elapses since the exceeding.

According to the disclosure, where the electronic percussion instrument threshold value setting part obtains a coefficient according to the hit position identified by the hit position identification part, sets a constant threshold value obtained by multiplying a value of the maximum of the detection signal by the coefficient for a predetermined time, and sets the gradual decrease line subsequent to the constant threshold value.

According to the disclosure, where the electronic percussion instrument predetermined time is set individually for each hit position identified by the hit position identification part.

According to the disclosure, where the electronic percussion instrument threshold value setting part obtains a gradual decrease rate according to the hit position identified by the hit position identification part, and set the gradual decrease line by consecutively multiplying the gradual decrease rate by a value obtained by multiplying the value of the maximum of the detection signal by the coefficient.

According to the disclosure, where the electronic percussion instrument threshold value setting part pre-stores multiple gradual decrease lines corresponding to the hit positions, and selects and sets one of the gradual decrease lines according to the hit position identified by the hit position identification part.

According to the disclosure, where the electronic percussion instrument body is comprised of an electronic cymbal having a bow part, an edge part or a cup part as the hit positions.

According to the disclosure, where the electronic percussion instrument body is comprised of an electronic drum having a head, a first rim or a second rim as the hit positions.

According to the disclosure, the sound source part includes: a hit position identification part configured to identify a hit position which has been hit based on the detection signal output from the hit detection part; a threshold value setting part configured to set a threshold value according to the hit position identified by the hit position identification part; and a musical sound production part configured to produce and output a predetermined musical sound based on the detection signal which has exceeded the threshold value set by the threshold value setting part. The threshold value set by the threshold value setting part forms a gradual decrease line that gradually decreases with a lapse of time, and the gradual decrease line is set individually for the hit position identified by the hit position identification part. Thus, a threshold value can be set in consideration of the vibration characteristics at each hit position, and even when the hit positions are consecutively hit, a musical sound according to each hit can be reliably produced and output.

According to the disclosure, the sound source part is configured to, after the detection signal output from the hit detection part exceeds a minimum of the threshold value, produce a musical sound corresponding to a maximum of the detection signal output in an interval until a predetermined time period elapses since the exceeding. Thus, an appropriate musical sound according to a hitting force can be output while preventing false detection of a hit.

According to the disclosure, the threshold value setting part obtains a coefficient according to the hit position identified by the hit position identification part, sets a constant threshold value obtained by multiplying a value of the maximum of the detection signal by the coefficient for a predetermined time, and sets the gradual decrease line subsequent to the constant threshold value. Thus, a relatively larger threshold value can be set in the predetermined time before a gradual decrease line is set, and false detection of a hit can be reliably prevented without affecting the detection of consecutive hits.

According to the disclosure, the predetermined time is set individually for the hit position identified by the hit position identification part. Thus, in the predetermined time before a gradual decrease line is set, a threshold value can be appropriately set according to the hit position, and false detection of a hit can be prevented more reliably.

According to the disclosure, the threshold value setting part obtains a gradual decrease rate according to the hit position identified by the hit position identification part, and sets the gradual decrease line by consecutively multiplying the gradual decrease rate by a value obtained by multiplying the value of the maximum of the detection signal by the coefficient. Thus, an appropriate gradual decrease line according to the maximum detection signal can be set individually for each hit, and false detection of a hit can be prevented while maintaining the performance of detection of consecutive hits.

According to the disclosure, the threshold value setting part pre-stores multiple gradual decrease lines corresponding to the hit positions, and selects and sets one of the gradual decrease lines according to the hit position identified by the hit position identification part. Thus, a gradual decrease line can be set more smoothly, as compared to when a gradual decrease line is sequentially calculated.

According to the disclosure, the body is comprised of an electronic cymbal having a bow part, an edge part or a cup part as the hit positions. Thus, a threshold value can be set in consideration of the vibration characteristics at each hit position in the electronic cymbal.

According to the disclosure, the body is comprised of an electronic drum having a head, a first rim or a second rim as the hit positions. Thus, a threshold value can be set in consideration of the vibration characteristics at each hit position in the electronic drum.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a three-side view illustrating the entire exterior of an electronic cymbal according to a first embodiment.

FIG. 2 is an exploded perspective view illustrating the electronic cymbal.

FIG. 3 is a sectional view taken along line III-III in FIG. 1.

FIG. 4 is a bottom view illustrating the electronic cymbal with its covering member removed.

FIG. 5 is a block diagram illustrating an outline of the configuration of the electronic cymbal (in common with a second embodiment).

FIG. 6 is a graph illustrating a vibration waveform (detection signal) and a gradual decrease line.

FIG. 7 is a graph illustrating a vibration waveform (detection signal) and a gradual decrease line when a bow part of the electronic cymbal is hit.

FIG. 8 is a graph illustrating a vibration waveform (detection signal) and a gradual decrease line when an edge part and a bow part of the electronic cymbal are consecutively hit.

FIG. 9a is a flowchart illustrating control in a sound source part of the electronic cymbal.

FIG. 9b is a flowchart illustrating control in the sound source part of the electronic cymbal.

FIG. 9c is a flowchart illustrating control in the sound source part of the electronic cymbal.

FIG. 9d is a flowchart illustrating control in the sound source part of the electronic cymbal.

FIG. 9e is a flowchart illustrating control in the sound source part of the electronic cymbal.

FIG. 10a is a flowchart illustrating control in a sound source part in another embodiment of the electronic cymbal.

FIG. 10b is a flowchart illustrating control in the sound source part in another embodiment of the electronic cymbal.

FIG. 10c is a flowchart illustrating control in the sound source part in another embodiment of the electronic cymbal.

FIG. 10d is a flowchart illustrating control in the sound source part in another embodiment of the electronic cymbal.

FIG. 11 is a three-side view illustrating the entire exterior of an electronic drum according to a second embodiment.

FIG. 12 is an exploded perspective view illustrating the electronic drum.

FIG. 13 is a sectional view taken along line XIII-XIII in FIG. 11.

FIG. 14a is a sectional view taken along line XIV-XIV in FIG. 11.

FIG. 14b is an exploded perspective view illustrating a second rim of the electronic drum.

FIG. 15a is a flowchart illustrating control in a sound source part of the electronic drum.

FIG. 15b is a flowchart illustrating control in the sound source part of the electronic drum.

FIG. 15c is a flowchart illustrating control in the sound source part of the electronic drum.

FIG. 15d is a flowchart illustrating control in the sound source part of the electronic drum.

FIG. 15e is a flowchart illustrating control in the sound source part of the electronic drum.

FIG. 15f is a flowchart illustrating control in the sound source part of the electronic drum.

FIG. 15g is a flowchart illustrating control in the sound source part of the electronic drum.

FIG. 15h is a flowchart illustrating control in the sound source part of the electronic drum.

Corresponding reference numerals indicate corresponding parts throughout the several views of the drawings.

### DETAILED DESCRIPTION

An embodiment of the present disclosure will be specifically described below with reference to the drawings.

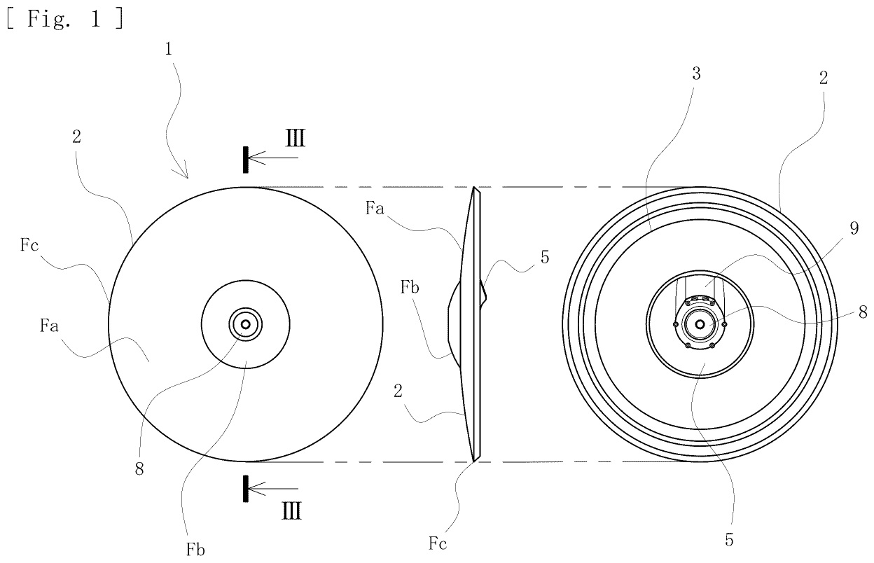

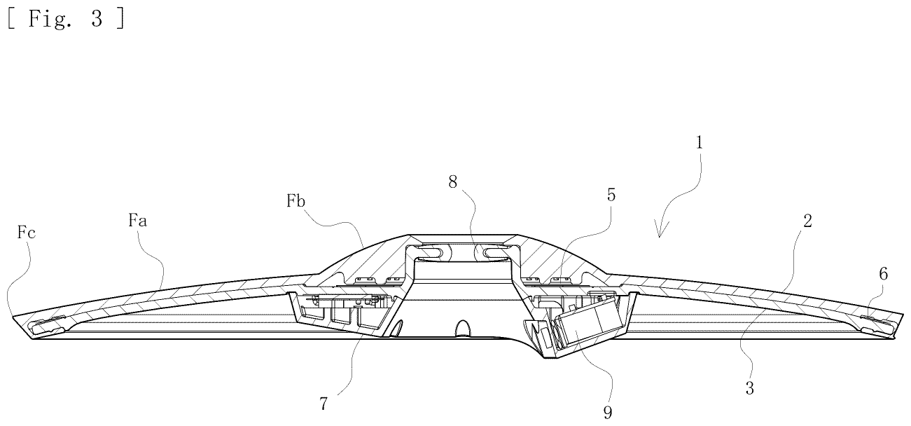

An electronic cymbal according to a first embodiment produces and outputs a predetermined musical sound based on a detection signal caused by a hit, thereby making it possible to achieve a performance similar to an acoustic cymbal performance. As illustrated in FIGS. 1 to 5, the electronic cymbal includes: a body 1; vibration sensors 4 (hit detection part); and a sound source part 10.

As illustrated in FIGS. 1 to 4, the body 1 includes: a pad 2 having a hitting surface F that a player can hit; and a frame 3 that supports the back surface side of the pad 2. The pad 2 is made of a material such as a rubber material or a soft resin (a silicone rubber in the present embodiment) that can be hit with a stick, and is comprised of a disk-shaped member having an opening at the center. The hitting surface F formed on the upper surface of the pad 2 includes a plurality of (three in the present embodiment) hit positions including a cup part Fb formed to bulge at the center of the pad 2; an edge part Fc formed on the peripheral edge of the pad 2; and a bow part Fa that is a region between the cup part Fb and the edge part Fc.

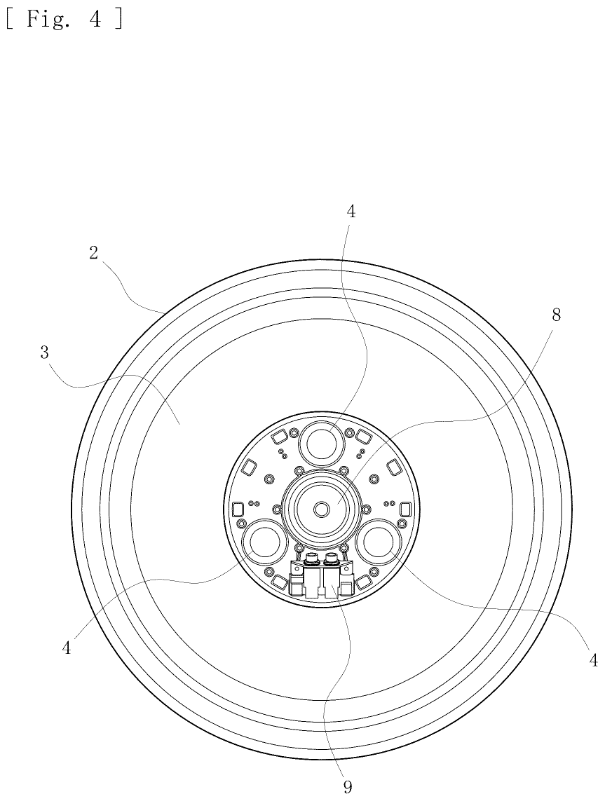

The frame 3 is made of a hard resin or a metal (ABS resin in the present embodiment), and the body 1 is formed by integrating the frame 3 with the pad 2 mounted on the surface of the frame 3. Furthermore, as illustrated in FIG. 4, a plurality of (three in the present embodiment) vibration sensors 4 (hit detection parts) are attached to the central back surface of the frame 3, in a concentric manner. An output terminal 9 is formed in a projecting manner. The vibration sensors 4 and the output terminal 9 are covered with a covering member 7. Note that a shaft sleeve 8 is mounted at the central position of the frame 3 to allow a support stand to be inserted therethrough.

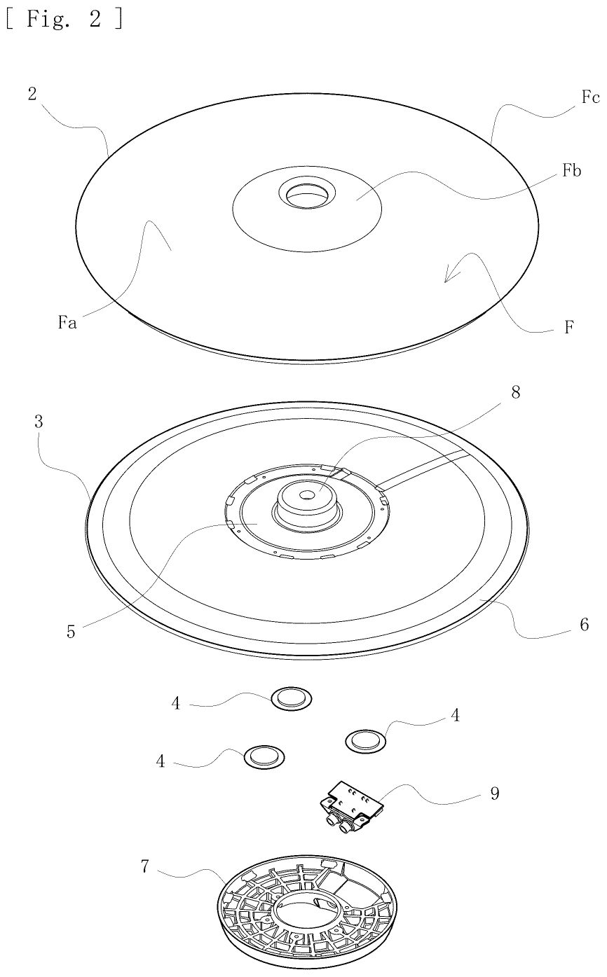

In the frame 3, according to the present embodiment as illustrated in FIG. 2, a cup sensor 5 is mounted at a position (central position) corresponding to the cup part Fb. An edge sensor 6 is mounted at a position (peripheral position) corresponding to the edge part Fc. These cup sensor 5 and edge sensor 6 can generate and output an ON signal when hit, and constitute the hit detection part of the present disclosure along with the vibration sensors 4.

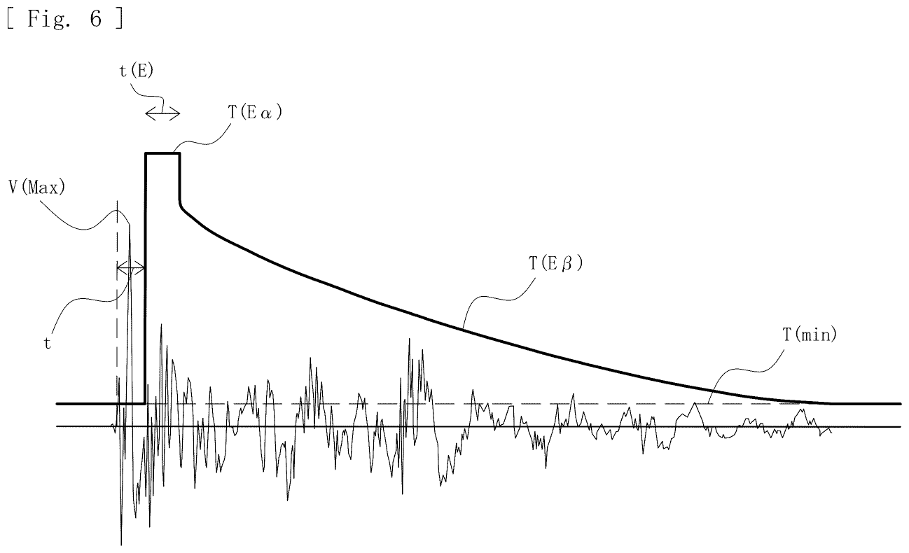

Each vibration sensor 4 includes a piezoelectric element capable of converting the vibration generated by a hit on the hitting surface F to an electrical signal, and configured to detect a hit at a hit position and output a predetermined detection signal. Specifically, upon transmission of vibration generated by a player hitting the hitting surface F, the vibration sensor 4 is bent in its entirety due to the vibration, and a voltage according to the amount of bending is generated. When a voltage is generated in this manner, a current flows through a connected wire, and output is made to the sound source part 10 as the output waveform (analog signal) as illustrated in FIGS. 6 to 8.

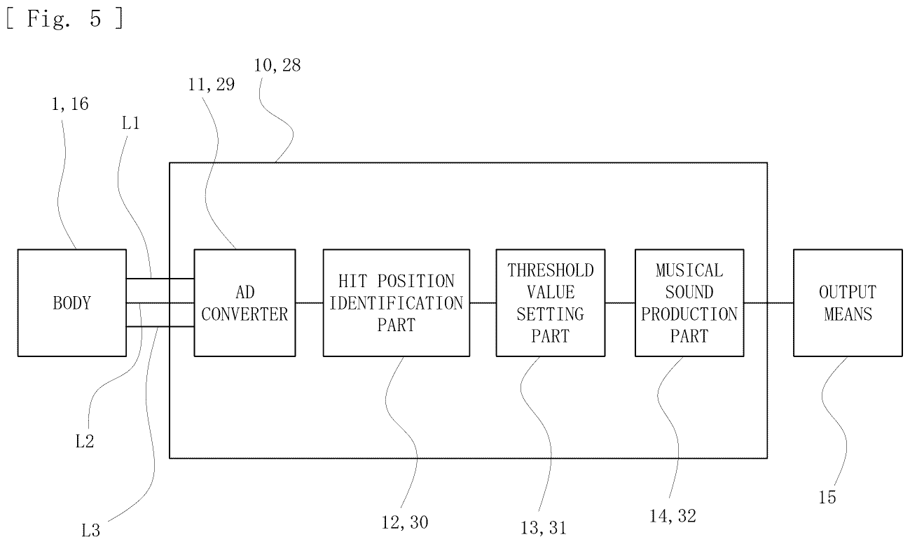

The sound source part 10 produces and outputs a predetermined musical sound based on the detection signal output from the vibration sensor 4, the cup sensor 5 and the edge sensor 6 serving as hit detection parts. The sound source part 10 includes an AD converter 11, a hit position identification part 12, a threshold value setting part 13, and a musical sound production part 14 as illustrated in FIG. 5. The AD converter 11 is electrically connected to each vibration sensor 4, the cup sensor 5 and the edge sensor 6 of the body 1 through wires L1 to L3, and configured to convert an analog signal detected by the vibration sensor 4 to a digital signal.

However, as illustrated in FIGS. 6 to 8, the sound source part 10, according to the present embodiment, is configured to, after the detection signal output from the vibration sensor 4 (hit detection part) exceeds a minimum threshold value T(min), produce a musical sound corresponding to a maximum detection signal (an output maximum value V(max)) output in an interval until a predetermined time period t elapses since the exceeding. Note that the minimum threshold value T(min) and the predetermined time period t are pre-set, and stored in a storage (such as a storage medium) included in the sound source part 10. For example, the predetermined time period t according to the present embodiment is set to approximately 2 ms ( 2/1000 seconds) after the threshold value is exceeded.

The hit position identification part 12 includes a microcomputer or the like electrically connected to the body 1 and the AD converter 11 through the wires L1 to L3, it identifies the hit positions that have been hit based on the output detection signal from the hit detection part (the cup sensor 5 and the edge sensor 6 in the present embodiment). Specifically, the hit position identification part 12 is configured to receive input of an ON signal and an OFF signal from the cup sensor 5, and an ON signal and an OFF signal from the edge sensor 6 through the AD converter 11 connected.

When the signal from the cup sensor 5 is ON and the signal from the edge sensor 6 is OFF, the hit position is identified to be the cup part Fb. When the signal from the cup sensor 5 is OFF and the signal from the edge sensor 6 is ON, the hit position is identified to be the edge part Fc. In all other cases, the hit position is identified to be the bow part Fa.

The threshold value setting part 13 includes the same microcomputer or the like as that of the hit position identification part 12 or another microcomputer or the like connected. The threshold value setting part 13 sets a threshold value according to the hit position identified by the hit position identification part 12. As illustrated in FIGS. 6 to 8, the threshold value set by the threshold value setting part 13, according to the present embodiment, forms constant threshold values (T(Eα), T(Bα)) (including T(Cα) which is not illustrated in FIGS. 6 to 8), and gradual decrease lines (T(Eβ), T(Bβ)) (including T(Cβ) which is not illustrated in FIGS. 6 to 8) which gradually decrease with a lapse of time. A gradual decrease line is set individually for each hit position identified by the hit position identification part 12.

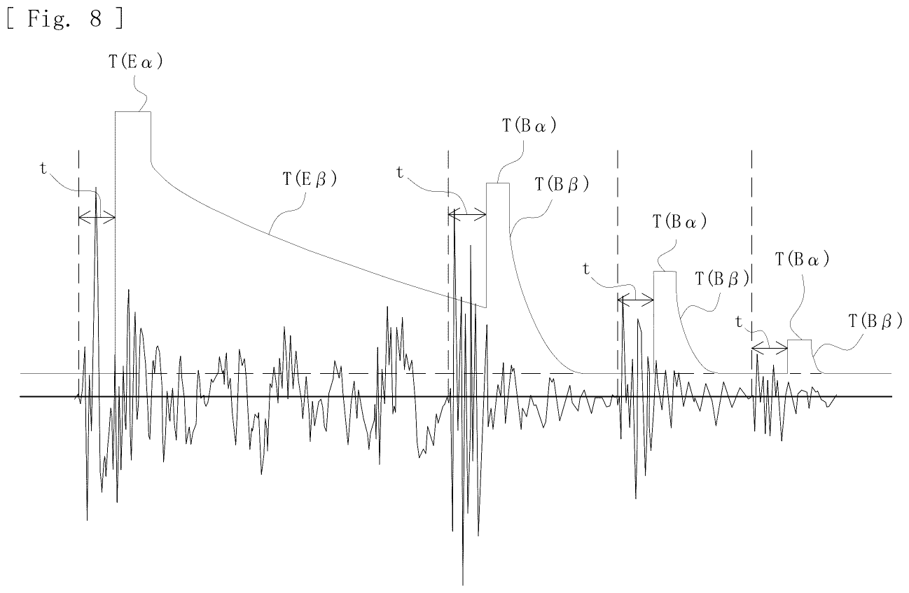

For example, when the hit position is identified to be the edge part Fc by the hit position identification part 12, as illustrated in FIGS. 6 and 8, the threshold value setting part 13 obtains a coefficient α(E) according to the identified edge part Fc, and sets (see FIGS. 6 and 8) a constant threshold value T(Eα) obtained by multiplying the value of the maximum detection signal (the output maximum value V(max)) by the coefficient α(E) for a predetermined time t(E). The predetermined time t(E) is set individually for each hit position identified by the hit position identification part 12.

Subsequently, a gradual decrease rate γ(E) according to the hit position (the edge part Fc) identified by the hit position identification part 12 is obtained, and a gradual decrease line T(Eβ) is set by consecutively multiplying the gradual decrease rate γ(E) (for each predetermined time) by the value obtained by multiplying the maximum detection signal (the output maximum value V(max)) by the previously obtained coefficient α(E). In this manner, when the hit position is identified to be the edge part Fc, the threshold value set by the threshold value setting part 13 forms the constant threshold value T(Eα) and the subsequent gradual decrease line T(Eβ).

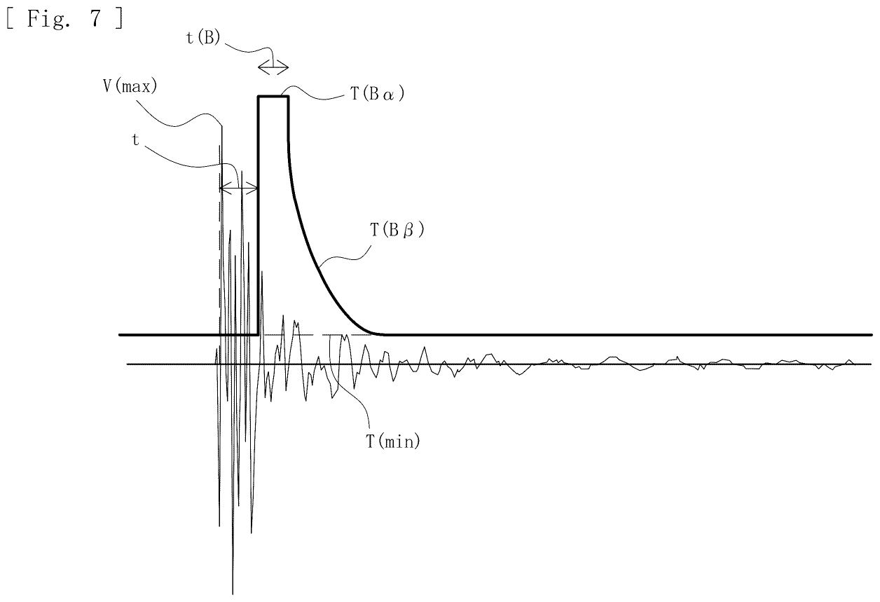

For example, when the hit position is identified to be the bow part Fa by the hit position identification part 12, as illustrated in FIGS. 7 and 8, the threshold value setting part 13 obtains a coefficient α(B) according to the identified bow part Fa, and sets (see FIGS. 6 and 8) constant threshold value T(Bα) obtained by multiplying the value of the maximum detection signal (the output maximum value V(max)) by the coefficient α(B) for a predetermined time t(B). The predetermined time t(B) is set individually for each hit position identified by the hit position identification part 12.

Subsequently, a gradual decrease rate γ(B) according to the hit position (the bow part Fa) identified by the hit position identification part 12 is obtained, and a gradual decrease line T(Bβ) is set by consecutively multiplying the gradual decrease rate γ(B) (for each predetermined time) by the value obtained by multiplying the maximum detection signal (the output maximum value V(max)) by the previously obtained coefficient α(B). In this manner, when the hit position is identified to be the bow part Fa, the threshold value set by the threshold value setting part 13 forms the constant threshold value T(Bα) and the subsequent gradual decrease line T(Bβ). The same also applies to when the hit position is identified to be the cup part Fc by the hit position identification part 12.

Note that the gradual decrease rate of the threshold value applied to each hit position is set based on a result of measurement of the gradual decrease rate of the waveform output from the vibration sensor 4 at the time of actual hitting of the hit position. Specifically, the gradual decrease rate of the threshold value applied to each hit position preferably has an equal or a slightly smaller value (value unlikely to be gradually decreased) than the gradual decrease rate of the waveform output from the vibration sensor 4 at the time of hitting of the hit position.

The musical sound production part 14 includes the same microcomputer or the like as that of the threshold value setting part 13 and the hit position identification part 12 or another microcomputer or the like is connected. The musical sound production part 14 produces and outputs a predetermined musical sound based on the detection signal which has exceeded the threshold value set by the threshold value setting part 13. For example, as illustrated in FIG. 8, the musical sound production part 14, when the detection signal detected by the vibration sensor 4 exceeds the gradual decrease line T(Eβ) as a threshold value set by the threshold value setting part 13, produces a musical sound (musical sound when the bow part Fa is hit hard in FIG. 8) corresponding to the maximum detection signal (the output maximum value V(max)) output in an interval until the predetermined time period t elapses since the exceeding.

The musical sound production part 14 is connected to an output 15 which is connected to the sound source part 10, thus the produced musical sound can be output to the output 15. The output 15 is a speaker and a headphone, by which a player and an audience actually listen to an output musical sound, and is configured to receive and output, through e.g., an electrical wire or an optical wire or wirelessly, the musical sound produced by the musical sound production part 14.

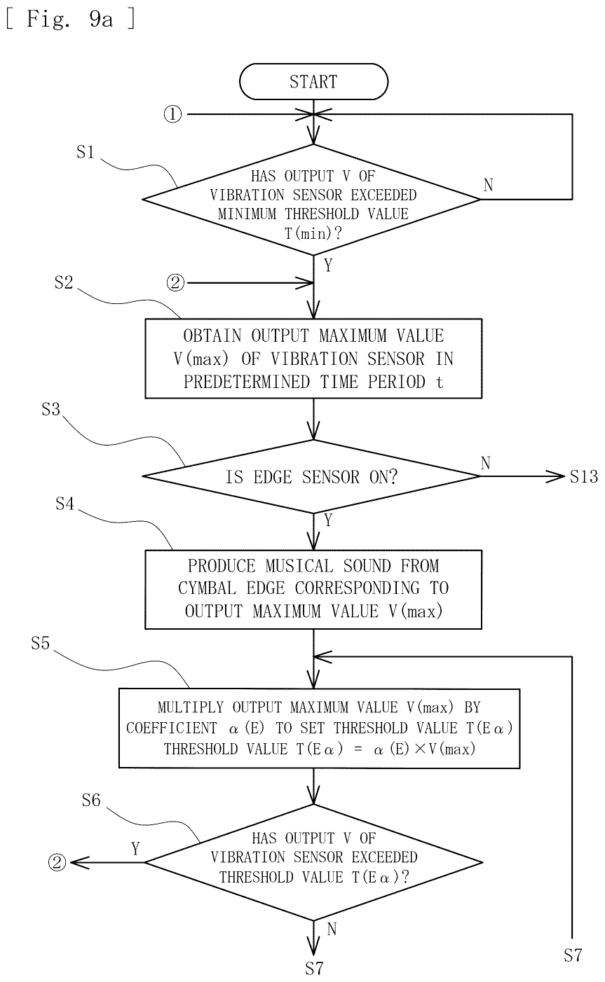

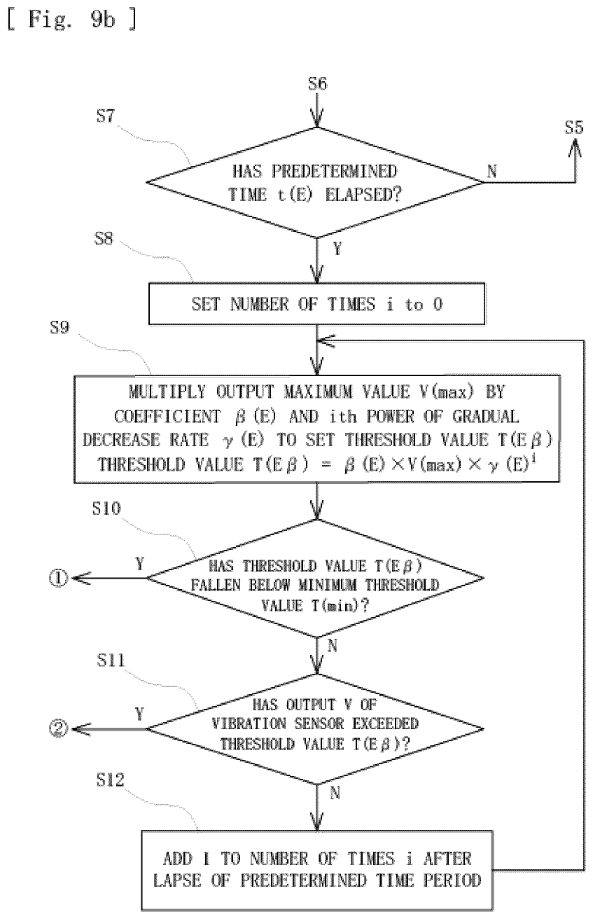

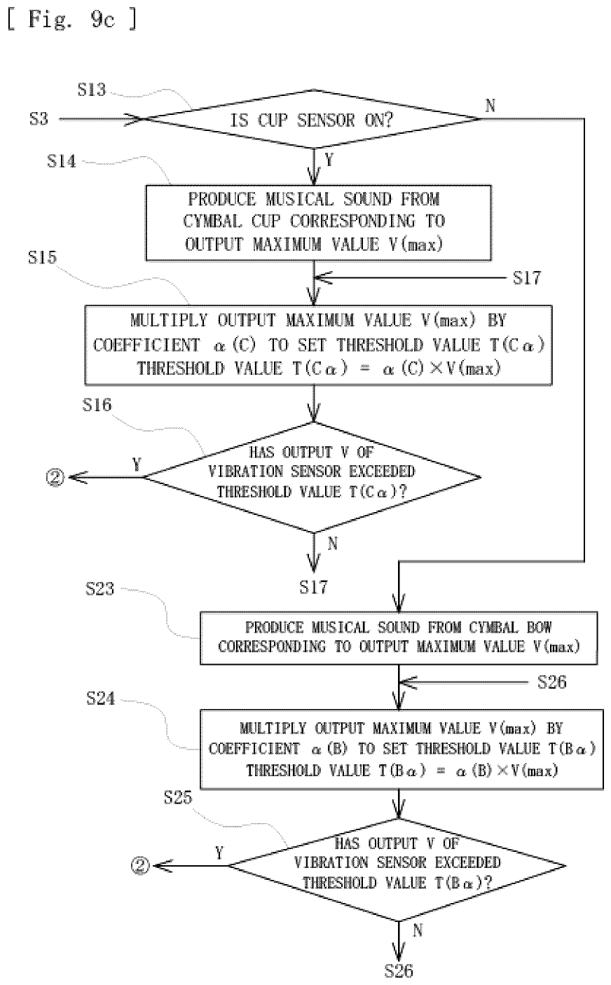

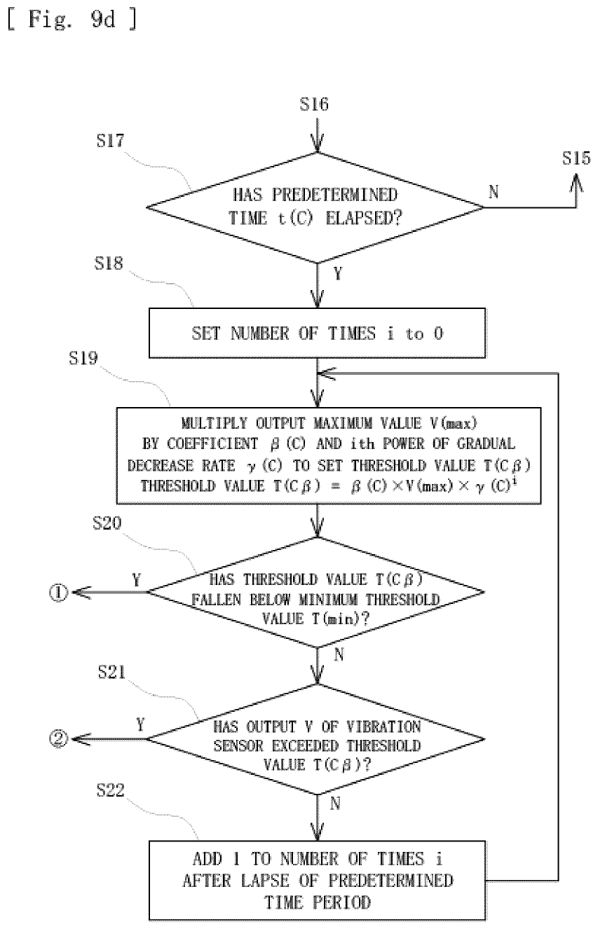

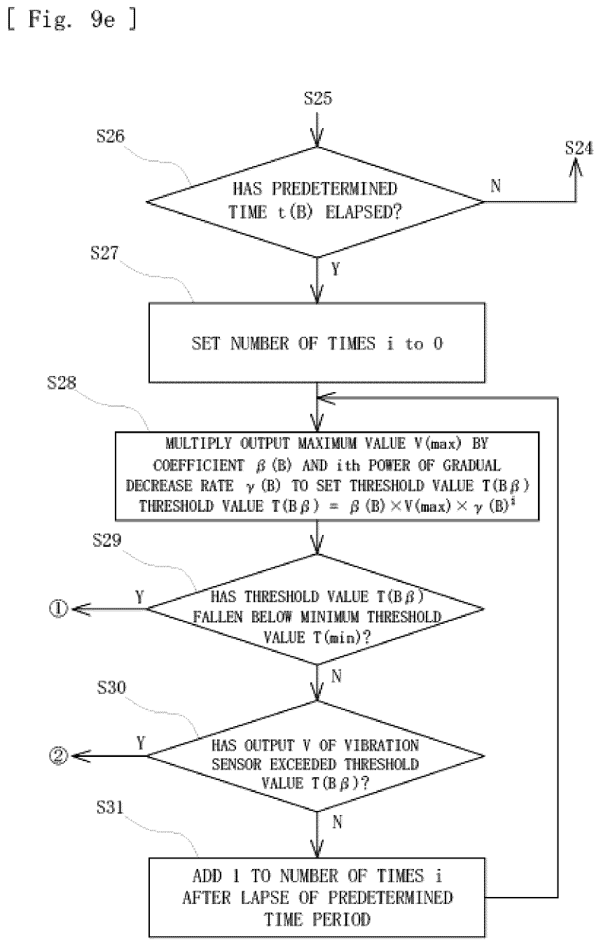

Next, the control of the sound source part 10 according to the present embodiment will be described based on FIGS. 9a to 9e.

First, in S1, it is determined whether the output V (detection signal) of the vibration sensor has exceeded the minimum threshold value T(min), and when the determination is affirmative, in S2, the output maximum value V(max) of the vibration sensor 4 in the predetermined time period is obtained. Subsequently, in S3, it is determined whether the edge sensor 6 is ON, and when the edge sensor 6 is determined to be ON, in S4, a musical sound (a musical sound when the edge part Fc is hit) from the cymbal edge corresponding to the output maximum value V(max) is produced by the output 15.

In S5, the output maximum value V(max) is multiplied by the coefficient α(E) to set the threshold value T(Eα) (constant threshold value), then it is determined in S6 whether the output V of the vibration sensor 4 has exceeded the threshold value T(Eα) (constant threshold value). In S6, when the output V of the vibration sensor 4 is determined to have exceeded the threshold value T(Eα) (constant threshold value), the flow returns to S2 and the subsequent control is repeated. When the output V of the vibration sensor 4 is determined not to have exceeded the threshold value T(Eα) (constant threshold value), it is determined in S7 whether the predetermined time t(E) has elapsed.

In S7, when the predetermined time t(E) is determined not to have elapsed, the flow returns to S5 and the subsequent control is repeated. When the predetermined time t(E) is determined to have elapsed, in S8, the number of times i is set to 0, and in S9, the output maximum value γ(max) is multiplied by the coefficient β(E) and ith power of the gradual decrease rate γ(E) to set a threshold value T(Eβ) (gradual decrease line). Subsequently, in S10, it is determined whether the threshold value T(Eβ) (gradual decrease line) has fallen below the minimum threshold value T(min). When the threshold value T(Eβ) is determined to have fallen below the minimum threshold value T(min), the flow returns to S1 and the control is repeated. When the threshold value T(Eβ) is determined not to have fallen below the minimum threshold value T(min), it is determined in S11 whether the output V of the vibration sensor 4 has exceeded the threshold value T(Eβ) (gradual decrease line).

In S11, when the output V of the vibration sensor 4 is determined to have exceeded the threshold value T(Eβ) (gradual decrease line), the flow returns to S2 and the subsequent control is repeated. When the output V of the vibration sensor 4 is determined not to have exceeded the threshold value T(Eβ) (gradual decrease line), in S12, after lapse of the predetermined time period, 1 is added to the number of times i, then in S9, the threshold value T(Eβ) (gradual decrease line) is set again, and subsequently, S10 to S12 are repeated.

Meanwhile, in S3, when the edge sensor 6 is determined not to be ON, it is determined in S13 whether the cup sensor 5 is ON. When the cup sensor 5 is determined to be ON, in S14, a musical sound (a musical sound when the cup part Fb is hit) from the cymbal cup corresponding to the output maximum value V(max) is produced by the output means 15.

In S15, the output maximum value V(max) is multiplied by the coefficient α(C) to set a threshold value T(Cα) (constant threshold value), then it is determined in S16 whether the output V of the vibration sensor 4 has exceeded the threshold value T(Cα) (constant threshold value). In S16, when the output V of the vibration sensor 4 is determined to have exceeded the threshold value T(Cα) (constant threshold value), the flow returns to S2 and the subsequent control is repeated. When the output V of the vibration sensor 4 is determined not to have exceeded the threshold value T(Cα) (constant threshold value), it is determined in S17 whether a predetermined time t(C) has elapsed.

In S17, when the predetermined time t(C) is determined not to have elapsed, the flow returns to S15 and the subsequent control is repeated. When the predetermined time t(C) is determined to have elapsed, in S18, the number of times i is set to 0, and in S19, the output maximum value V(max) is multiplied by the coefficient β(C) and ith power of the gradual decrease rate γ(C) to set a threshold value T(Cβ) (gradual decrease line). Subsequently, in S20, it is determined whether the threshold value T(Cβ) (gradual decrease line) has fallen below the minimum threshold value T(min). When the threshold value T(Cβ) is determined to have fallen below the minimum threshold value T(min), the flow returns to S1 and the control is repeated. When the threshold value T(Cβ) is determined not to have fallen below the minimum threshold value T(min), it is determined in S21 whether the output V of the vibration sensor 4 has exceeded the threshold value T(Cβ) (gradual decrease line).

In S21, when the output V of the vibration sensor 4 is determined to have exceeded the threshold value T(Cβ) (gradual decrease line), the flow returns to S2 and the subsequent control is repeated. When the output V of the vibration sensor 4 is determined not to have exceeded the threshold value T(Cβ) (gradual decrease line), in S22, after lapse of the predetermined time period, 1 is added to the number of times i, then in S19, the threshold value T(Cβ) (gradual decrease line) is set again, and subsequently, S20 to S22 are repeated.

Meanwhile, in S13, when the cup sensor 5 is determined not to be ON, in S23, a musical sound (a musical sound when the bow part Fa is hit) from the cymbal bow corresponding to the output maximum value V(max) is produced by the output 15. In S24, the output maximum value V(max) is multiplied by the coefficient α(B) to set the threshold value T(Bα) (constant threshold value), then it is determined in S25 whether the output V of the vibration sensor 4 has exceeded the threshold value T(Bα) (constant threshold value). In S25, when the output V of the vibration sensor 4 is determined to have exceeded the threshold value T(Bα) (constant threshold value), the flow returns to S2 and the subsequent control is repeated. When the output V of the vibration sensor 4 is determined not to have exceeded the threshold value T(Bα) (constant threshold value), it is determined in S26 whether the predetermined time t(B) has elapsed.

In S26, when the predetermined time t(B) is determined not to have elapsed, the flow returns to S24 and the subsequent control is repeated. When the predetermined time t(B) is determined to have elapsed, in S27, the number of times i is set to 0, and in S28, the output maximum value V(max) is multiplied by a coefficient β(B) and ith power of the gradual decrease rate γ(B) to set a threshold value T(Bβ) (gradual decrease line). Subsequently, in S29, it is determined whether the threshold value T(Bβ) (gradual decrease line) has fallen below the minimum threshold value T(min). When the threshold value T(Bβ) is determined to have fallen below the minimum threshold value T(min), the flow returns to S1 and the control is repeated. When the threshold value T(Bβ) is determined not to have fallen below the minimum threshold value T(min), it is determined in S30 whether the output V of the vibration sensor 4 has exceeded the threshold value T(Bβ) (gradual decrease line).

In S30, when the output V of the vibration sensor 4 is determined to have exceeded the threshold value T(Bβ) (gradual decrease line), the flow returns to S2 and the subsequent control is repeated. When the output V of the vibration sensor 4 is determined not to have exceeded the threshold value T(Bβ) (gradual decrease line), in S31, after lapse of the predetermined time period, 1 is added to the number of times i, then in S28, the threshold value T(Bβ) (gradual decrease line) is set again, and subsequently, S29 to S31 are repeated.

In the above-described embodiment, the threshold value setting part 13 obtains the gradual decrease rates (γ(E), γ(C), γ(B)) according to the hit positions identified by the hit position identification part 12, and sets the gradual decrease lines (T(Eβ), T(Cβ), T(Bβ)) by consecutively multiplying the gradual decrease rates (γ(E), γ(C), γ(B)) by the value obtained by multiplying the value (the output maximum value V(max)) of the maximum detection signal by the coefficients (β(E), β(C), β(B)). However, multiple gradual decrease lines according to the hit positions may be pre-stored, and a gradual decrease line may be selected and set according to the hit position identified by the hit position identification part 12.

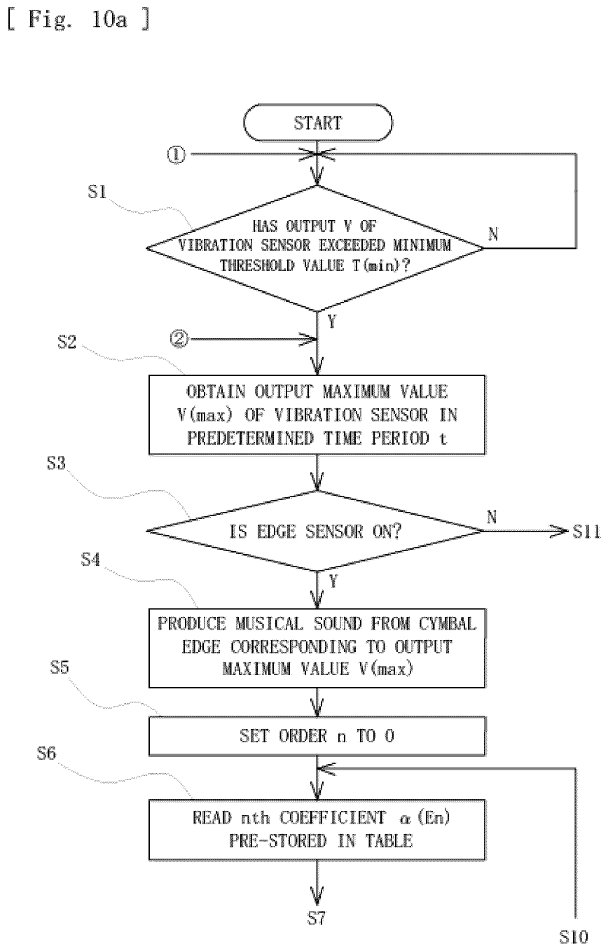

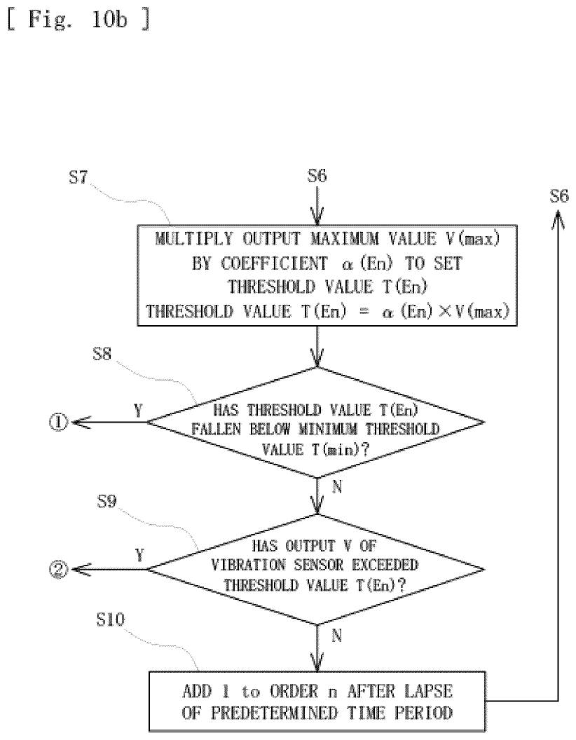

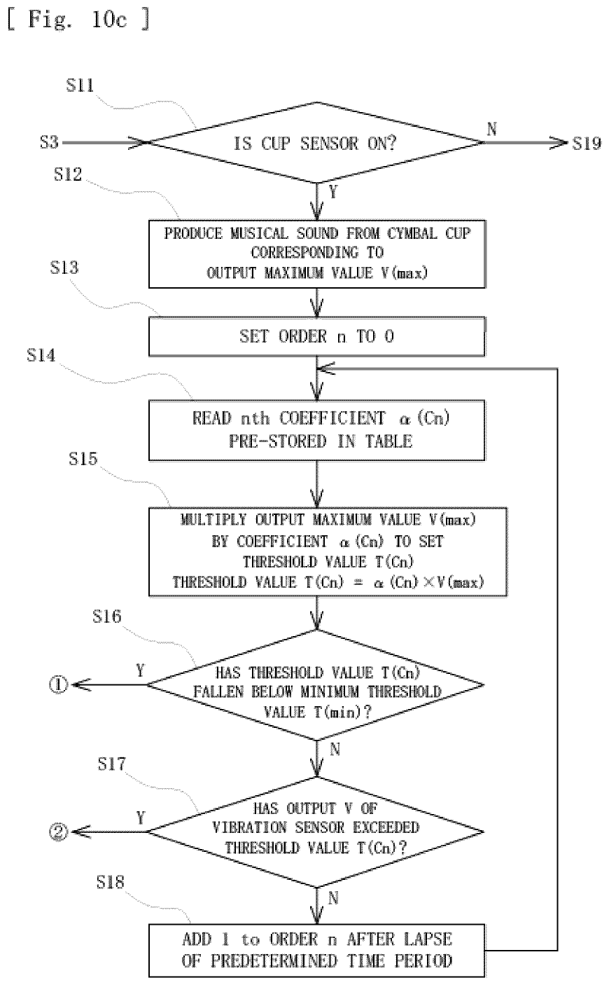

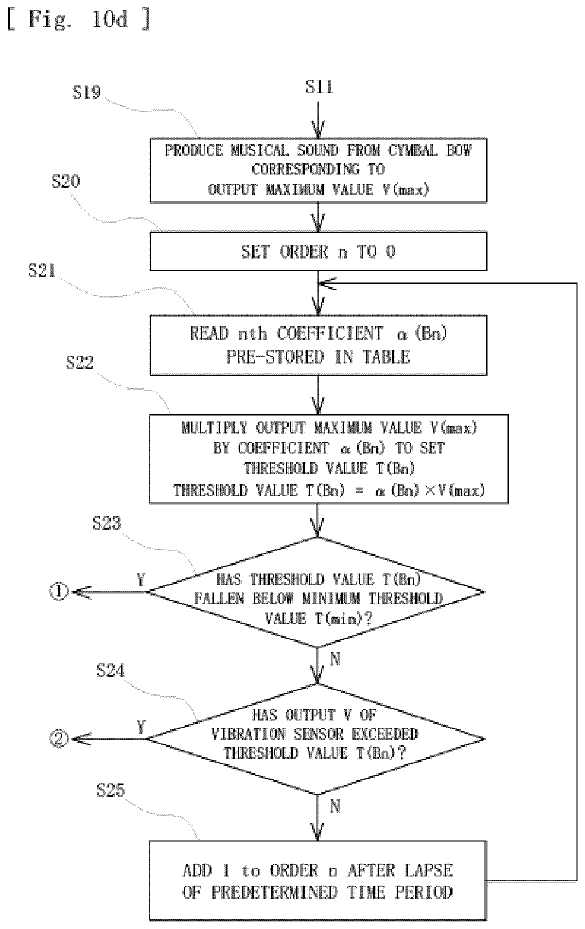

The control of the sound source part 10 when multiple gradual decrease lines according to the hit positions are pre-stored and a gradual decrease line is selected and set according to the hit position identified by the hit position identification part 12 will be described below based on FIGS. 10a to 10d.

First, in S1, it is determined whether the output V (detection signal) of the vibration sensor has exceeded the minimum threshold value T(min), and when the determination is affirmative, in S2, the output maximum value V(max) of the vibration sensor 4 in the predetermined time period is obtained. Subsequently, in S3, it is determined whether the edge sensor 6 is ON, and when the edge sensor 6 is determined to be ON, in S4, a musical sound (a musical sound when the edge part Fc is hit) from the cymbal edge corresponding to the output maximum value V(max) is produced by the output means 15.

In S5, the order n is set to 0, then in S6, the nth coefficient α(En) pre-stored in a table is read. Then in S7, the output maximum value V(max) is multiplied by the coefficient α(En) to set a threshold value T(En) (gradual decrease line). Subsequently, in S8, it is determined whether the threshold value T(En) (gradual decrease line) has fallen below the minimum threshold value T(min). When the threshold value T(En) is determined to have fallen below the minimum threshold value T(min), the flow returns to S1 and the control is repeated. When the threshold value T(En) is determined not to have fallen below the minimum threshold value T(min), it is determined in S9 whether the output V of the vibration sensor 4 has exceeded the threshold value T(En) (gradual decrease line).

In S9, when the output V of the vibration sensor 4 is determined to have exceeded the threshold value T(En) (gradual decrease line), the flow returns to S2 and the subsequent control is repeated. When the output V of the vibration sensor 4 is determined not to have exceeded the threshold value T(En) (gradual decrease line), in S10, after lapse of the predetermined time period, 1 is added to the order n, then in S6, the nth coefficient α(En) pre-stored in a table is read again, and subsequently, S7 to S10 are repeated.

Meanwhile, in S3, when the edge sensor 6 is determined not to be ON, it is determined in S11 whether the cup sensor 5 is ON. When the cup sensor 5 is determined to be ON, in S12, a musical sound (a musical sound when the cup part Fb is hit) from the cymbal cup corresponding to the output maximum value V(max) is produced by the output 15.

In S13, the order n is set to 0, then in S14, the nth coefficient α(Cn) pre-stored in a table is read. Then in S15, the output maximum value V(max) is multiplied by the coefficient α(Cn) to set a threshold value T(Cn) (gradual decrease line). Subsequently, in S16, it is determined whether the threshold value T(Cn) (gradual decrease line) has fallen below the minimum threshold value T(min). When the threshold value T(Cn) is determined to have fallen below the minimum threshold value T(min), the flow returns to S1 and the control is repeated. When the threshold value T(Cn) is determined not to have fallen below the minimum threshold value T(min), it is determined in S17 whether the output V of the vibration sensor 4 has exceeded the threshold value T(Cn) (gradual decrease line).

In S17, when the output V of the vibration sensor 4 is determined to have exceeded the threshold value T(Cn) (gradual decrease line), the flow returns to S2 and the subsequent control is repeated. When the output V of the vibration sensor 4 is determined not to have exceeded the threshold value T(Cn) (gradual decrease line), in S18, after lapse of the predetermined time period, 1 is added to the order n, then in S14, the nth coefficient α(Cn) pre-stored in a table is read again, and subsequently, S15 to S18 are repeated.

Meanwhile, in S11, when the cup sensor 5 is determined not to be ON, in S19, a musical sound (a musical sound when the bow part Fa is hit) from the cymbal bow corresponding to the output maximum value V(max) is produced by the output 15. In S20, the order n is set to 0, then in S21, the nth coefficient α(Bn) pre-stored in a table is read. Then in S22, the output maximum value V(max) is multiplied by the coefficient α(Bn) to set a threshold value T(Bn) (gradual decrease line).

Subsequently, in S23, it is determined whether the threshold value T(Bn) (gradual decrease line) has fallen below the minimum threshold value T(min). When the threshold value T(Bn) is determined to have fallen below the minimum threshold value T(min), the flow returns to S1 and the control is repeated. When the threshold value T(Bn) is determined not to have fallen below the minimum threshold value T(min), it is determined in S24 whether the output V of the vibration sensor 4 has exceeded the threshold value T(Bn) (gradual decrease line).

In S24, when the output V of the vibration sensor 4 is determined to have exceeded the threshold value T(Bn) (gradual decrease line), the flow returns to S2 and the subsequent control is repeated. When the output V of the vibration sensor 4 is determined not to have exceeded the threshold value T(Bβ) (gradual decrease line), in S25, after lapse of the predetermined time period, 1 is added to the order n, then in S21, the nth coefficient α(Bn) pre-stored in a table is read again, and subsequently, S22 to S25 are repeated.

Next, an electronic drum according to a second embodiment of the present disclosure will be described.

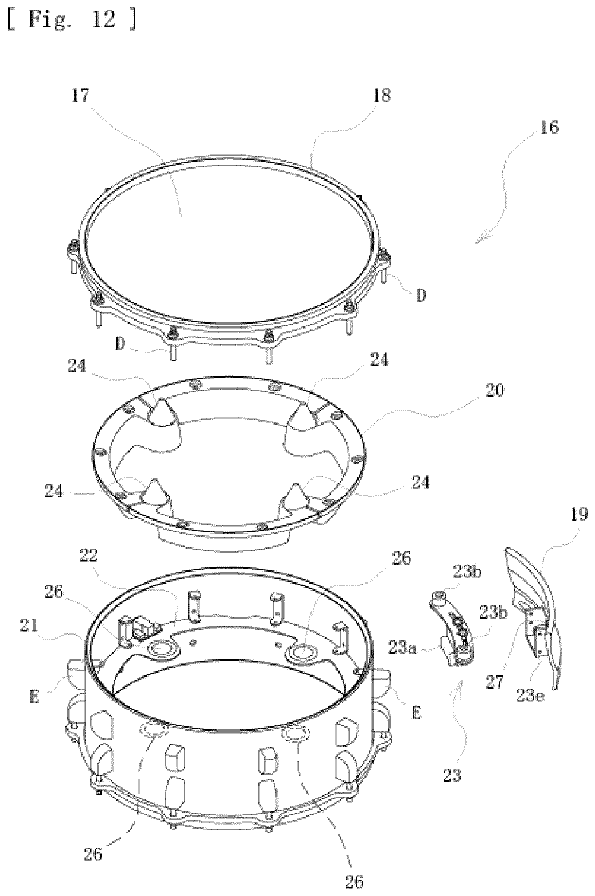

The electronic drum according to the second embodiment produces and outputs a predetermined musical sound based on a detection signal caused by a hit, thereby making it possible to achieve a performance similar to an acoustic drum performance. As illustrated in FIGS. 11 to 14 and FIG. 5, the electronic drum includes: a body 16; head sensors 25 with a vibration sensor; first rim sensors 26 and a second rim sensor 27 (hit detection parts); and a sound source part 28.

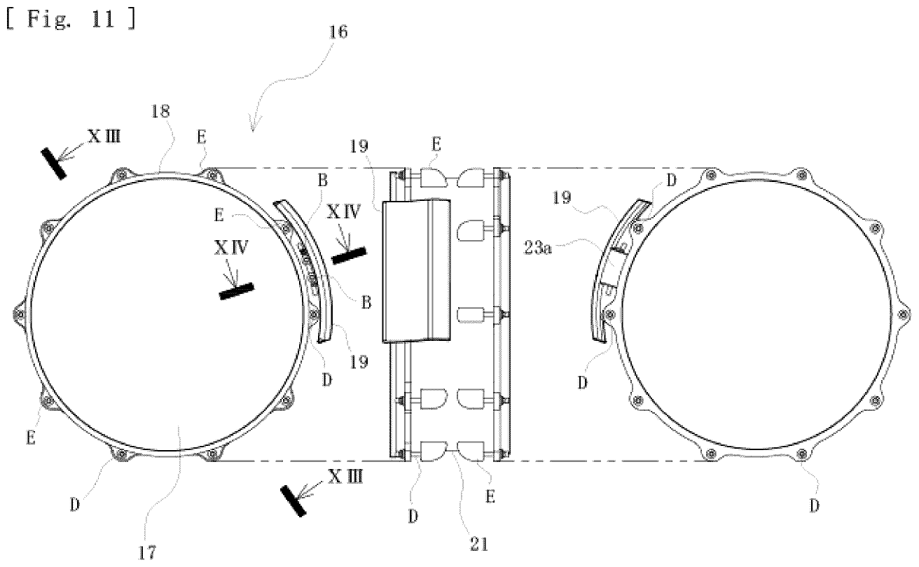

As illustrated in FIGS. 11 to 13, the body 16 includes: a plurality of (three in the present embodiment) hit positions including a head 17, a first rim 18 (rim) and a second rim 19 (side rim) that a player can hit; an annular cover 20 where the head sensors 25 are mounted; a cylindrical housing 21 where the first rim sensors 26 are mounted; and a support member 23 to mount the second rim 19 on the housing 21.

The first rim 18 includes an annular member made of metal covered with an elastic body such as EPDM rubber and PVC, and includes the head 17 made of PET, nylon or the like mounted on the inside of the first rim 18. The first rim 18 is tightened and fixed to rug E formed on the outer peripheral surface of the housing 21 in a projecting manner by tension bolts D. The housing 21 is mounted with an annular plate 22 along the inner circumference, and four first rim sensors 26 are mounted at regular intervals in a circumferential direction of the plate 22.

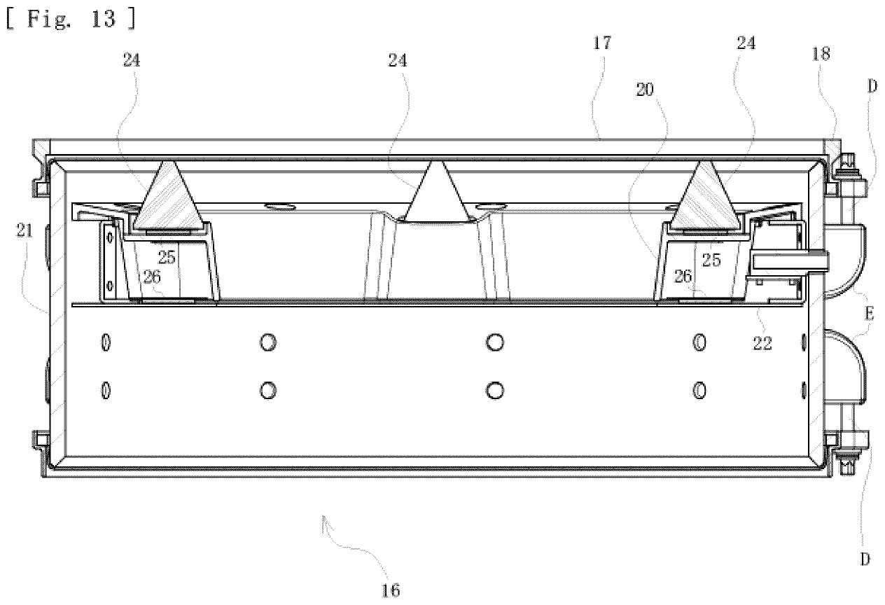

The annular cover 20 is fixed to the inside of the housing part 21, and four conical head sensor cushions 24 are mounted at regular intervals in a circumferential direction of the cover 20. As illustrated in FIG. 13, each head sensor cushion 24 is installed with its tip end in contact with the head 17 and its bottom surface mounted with the head sensors 25. When the head 17 is hit, the head sensors 25 detect vibration through the head sensor cushions 24, and outputs a predetermined detection signal. When the first rim 18 is hit, the first rim sensors 26 detect vibration through the housing 21, and output a predetermined detection signal.

The second rim 19 is elastically supported and mounted on the housing 21 of the body 16, and can be hit by a player, and in the present embodiment, is separately mounted on the housing 21 with elastic bodies 23a, 23b interposed therebetween. The, and the second rim sensor 27 is mounted on the second rim 19. When the second rim 19 is hit, the second rim sensor 27 detects vibration, and outputs a predetermined detection signal.

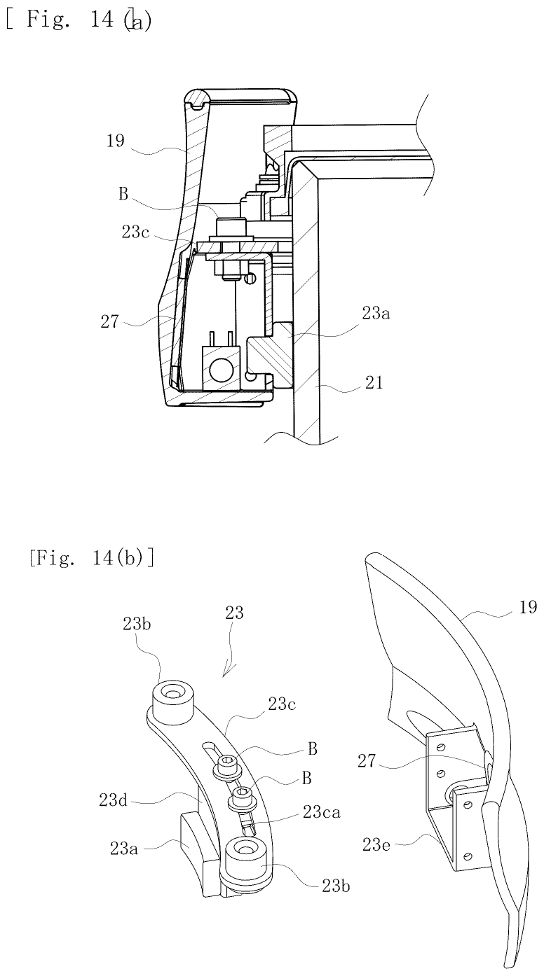

The support member 23 is for elastically supporting the second rim 19 on the lateral side of the housing 21, and as illustrated in (a), (b) of FIG. 14, includes: the elastic bodies 23a, 23b made of a rubber material or the like; an arc-shaped support plate 23c; a support stay 23d; and a support member 23e. The support member 23e includes a U-shaped metal stay, and fixed to the second rim 19.

The support plate 23c extends in an arc shape along the profile of the outer peripheral surface of the housing 21, and a long hole 23ca is formed along the arc shape. Two bolts B are inserted into the long hole 23ca, and the support stay 23d is secured by the bolts B. The support stay 23d is comprised of a metal component formed in an L shape, and mounted with a block-shape elastic body 23a. The elastic body 23b is fixed to both ends of the support stay 23d, and allows a tension bolt D to be internally inserted.

Meanwhile, the support member 23e of the second rim 19 is fixed and integrated with the support stay 23d using screws or the like, and a tension bolt D is inserted and screwed into each elastic body 23b, and the second rim 19 is thereby mounted on the lateral side of the housing 21. At this point, the support plate 23c is assembled with the tension bolts D via the elastic bodies 23b, and as illustrated in (a) of FIG. 14, the elastic body 23a is in contact with the lateral surface of the housing 21, and the second rim 19 is elastically supported on the housing 21.

The second rim 19 is movable with the support stay 23d along the outer peripheral surface of the housing 21 by loosening the bolts B and moving the second rim 19 along the long hole 23ca. Tightening the bolts B at any position causes the second rim 19 to be fixed to a desired position. In this manner, the second rim 19 according to the present embodiment is slidable along the peripheral edge of the first rim 18. Thus, the second rim 19 can be arranged at any position at which a player can comfortably play, and a good performance can thereby be achieved.

The sound source part 28 produces and outputs a predetermined musical sound based on the detection signal output from the head sensors 25, the first rim sensors 26 and the second rim sensor 27 serving as the hit detection parts. It includes an AD converter 29, a hit position identification part 30, a threshold value setting part 31, and a musical sound production part 32 as illustrated in FIG. 5. The AD converter 29 is electrically connected to the head sensors 25, the first rim sensors 26 and the second rim sensor 27 of the body 16 through wires L1, L2, L3, and configured to convert an analog signal detected by these sensors to a digital signal.

Meanwhile, the sound source part 28, according to the present embodiment, after the detection signal output from the head sensors 25, the first rim sensors 26 and the second rim sensor 27 (the hit detection parts) exceeds a minimum threshold value T(min), produces a musical sound corresponding to the maximum detection signal (the output maximum value V(max)) output in an interval until the predetermined time period t elapses since the exceeding. Note that the minimum threshold value T(min) and the predetermined time period t are pre-set, and stored in a storage (such as a storage medium) included in the sound source part 28.

The hit position identification part 30 includes a microcomputer or the like electrically connected to the body 16 via the AD converter 29 through the wires L1 to L3. It identifies the hit positions which have been hit based on the output detection signal from the hit detection parts (the head sensors 25, the first rim sensors 26 and the second rim sensor 27 in the present embodiment). Specifically, output maximum values V(Hmax), V(R1max), V(R2max) from the head sensors 25, the first rim sensors 26 and the second rim sensor 27 are compared, and one of the hit positions, having a highest proportion of output maximum value is identified to be hit.

The threshold value setting part 31 includes the same microcomputer or the like as that of the hit position identification part 30 or another microcomputer or the like connected. It sets a threshold value according to the hit position identified by the hit position identification part 30. The threshold value set by the threshold value setting part 31 according to the present embodiment forms constant threshold values (T(Hα), T(R1α), T(R2α), and gradual decrease lines (T(Hβ), T(R1β), T(R2β)) which gradually decrease with a lapse of time. The gradual decrease line is set individually for each hit position identified by the hit position identification part 30.

For example, when the hit position is identified to be the head 17 by the hit position identification part 30, the threshold value setting part 31 obtains a coefficient α(H) according to the identified head 17, and sets, for a predetermined time t(H), constant threshold value T(Hα) obtained by multiplying the value of a maximum detection signal (an output maximum value V(Hmax)) by the coefficient α(H). The predetermined time t(H) is set individually for each hit position identified by the hit position identification part 30.

Subsequently, a gradual decrease rate γ(H) according to the hit position (the head 17) identified by the hit position identification part 30 is obtained, and a gradual decrease line T(Hβ) is set by consecutively multiplying the gradual decrease rate γ(H) (for each predetermined time) by the value obtained by multiplying the maximum detection signal (the output maximum value V(Hmax)) by the previously obtained coefficient β(H). In this manner, when the hit position is identified to be the head 17, the threshold value set by the threshold value setting part 31 is formed by the constant threshold value T(Hα) and the subsequent gradual decrease line T(Hβ).

For example, when the hit position is identified to be the second rim 19 by the hit position identification part 30, the threshold value setting part 31 obtains a coefficient α(R2) according to the identified second rim 19, and sets, for a predetermined time t(R2), constant threshold value T(R2α) obtained by multiplying the value of the maximum detection signal (the output maximum value V(R2max)) by the coefficient α(R2). The predetermined time t(R2) is set individually for each hit position identified by the hit position identification part 30.

Subsequently, a gradual decrease rate γ(R2) according to the hit position (the second rim 19) identified by the hit position identification part 30 is obtained, and a gradual decrease line T(R2β) is set by consecutively multiplying the gradual decrease rate γ(R2) (for each predetermined time) by the value obtained by multiplying the maximum detection signal (the output maximum value V(R2max)) by the previously obtained coefficient β(R2). In this manner, when the hit position is identified to be the second rim 19, the threshold value set by the threshold value setting part 31 is formed by the constant threshold value T(R2α) and the subsequent gradual decrease line T(R2β). Note that when the hit position is identified to be the first rim 18, the threshold value set by the threshold value setting part 31 is formed by the constant threshold value T(R1α) and the subsequent gradual decrease line T(R1β).

The musical sound production part 32 includes the same microcomputer or the like as that of the threshold value setting part 31 and the hit position identification part 30 or another microcomputer or the like connected. As in the musical sound production part 14 in the first embodiment, the musical sound production parts 3 produces and outputs a predetermined musical sound based on the detection signal which has exceeded the threshold value set by the threshold value setting part 31. The musical sound production part 32 is connected to the output 15 which is connected to the sound source part 28, thus the produced musical sound is output to the output 15. The output 15 is similar to that of the first embodiment.

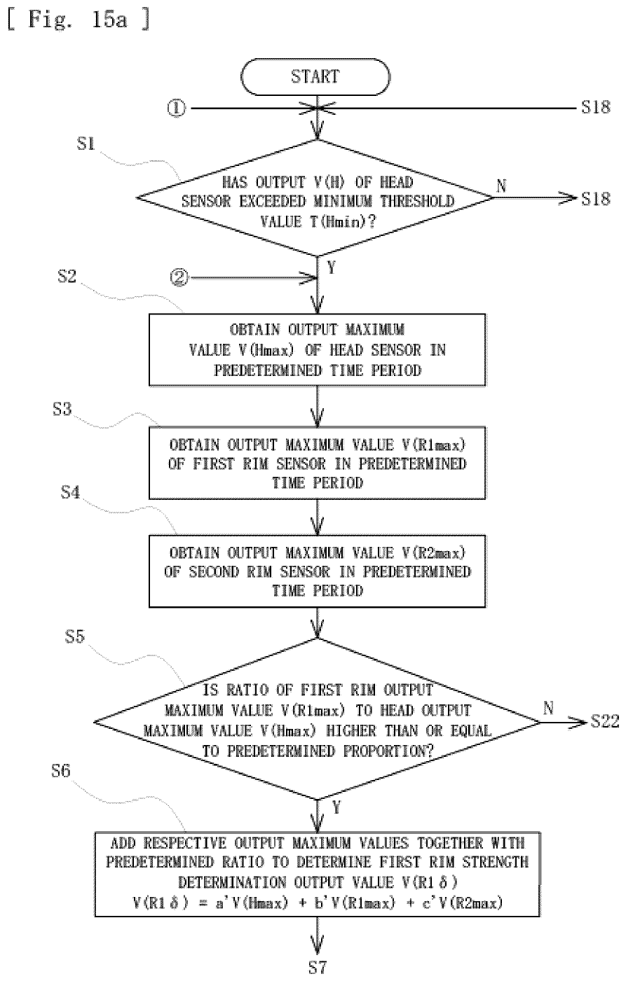

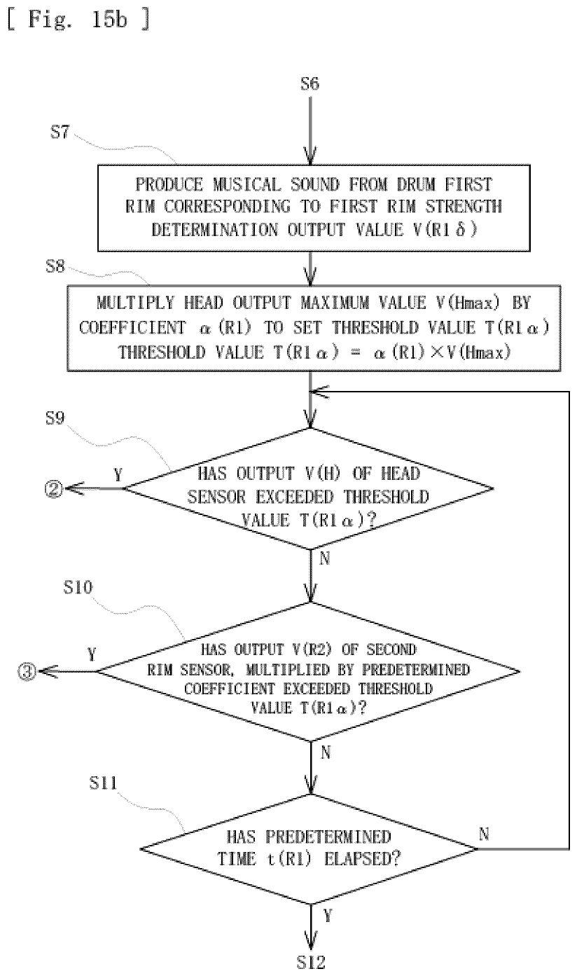

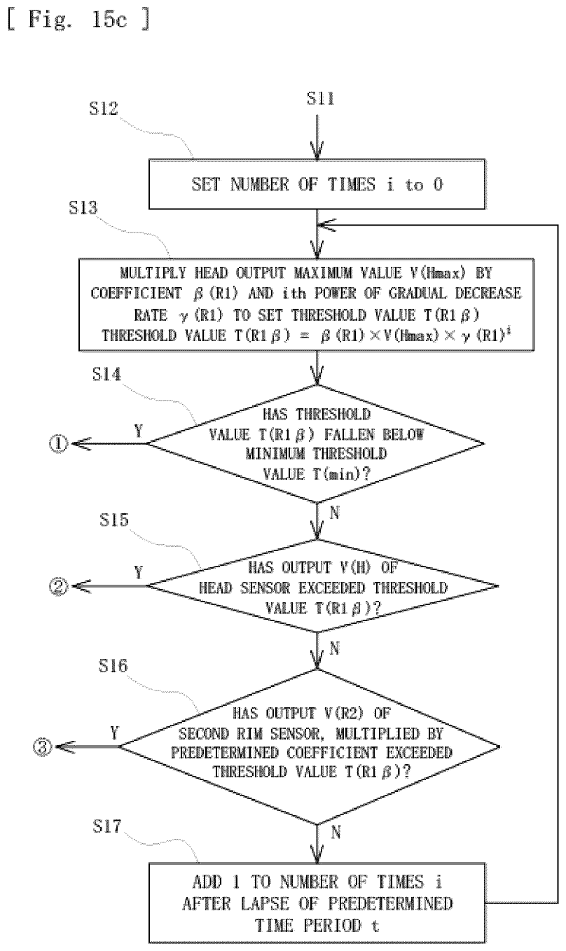

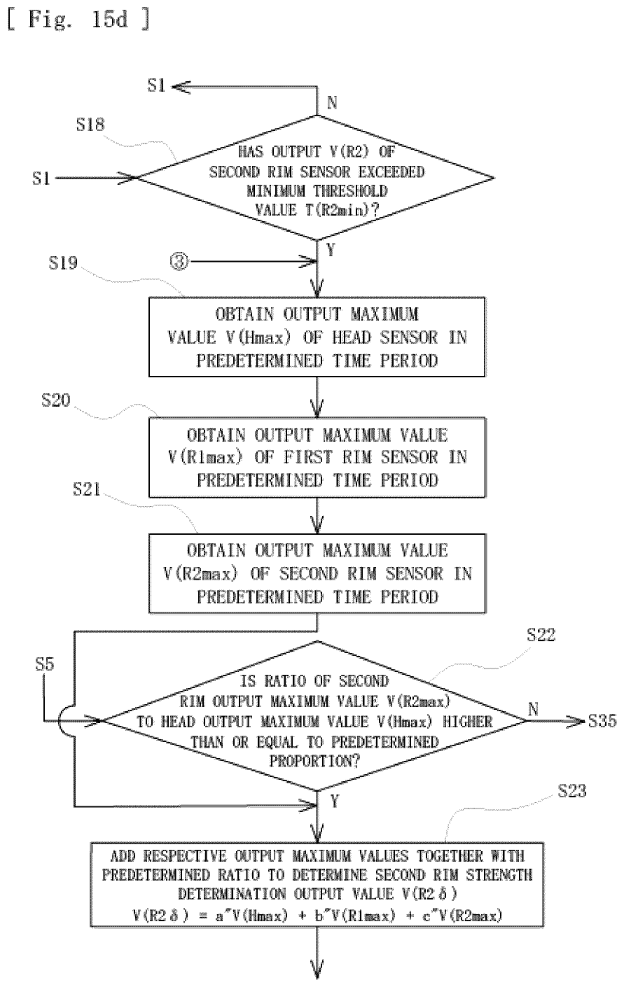

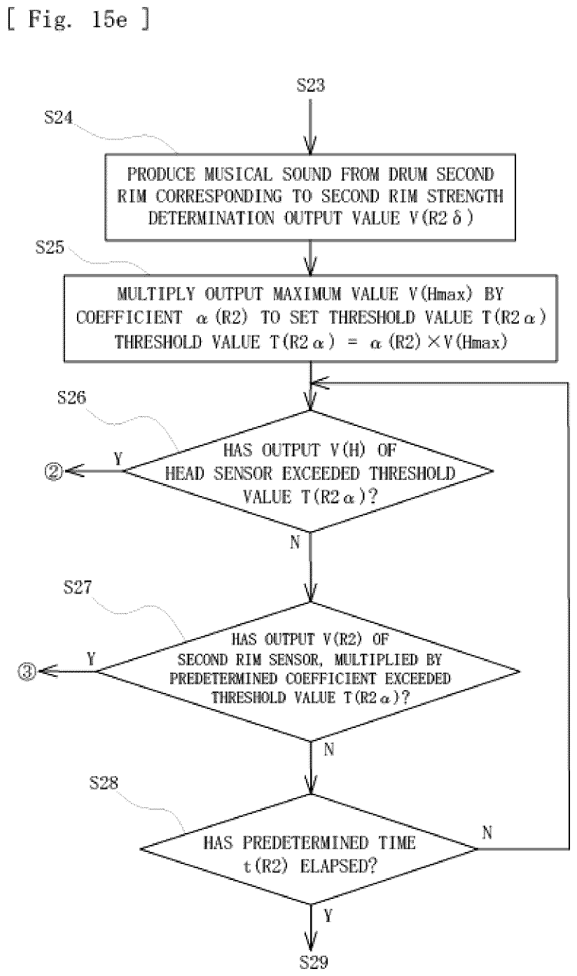

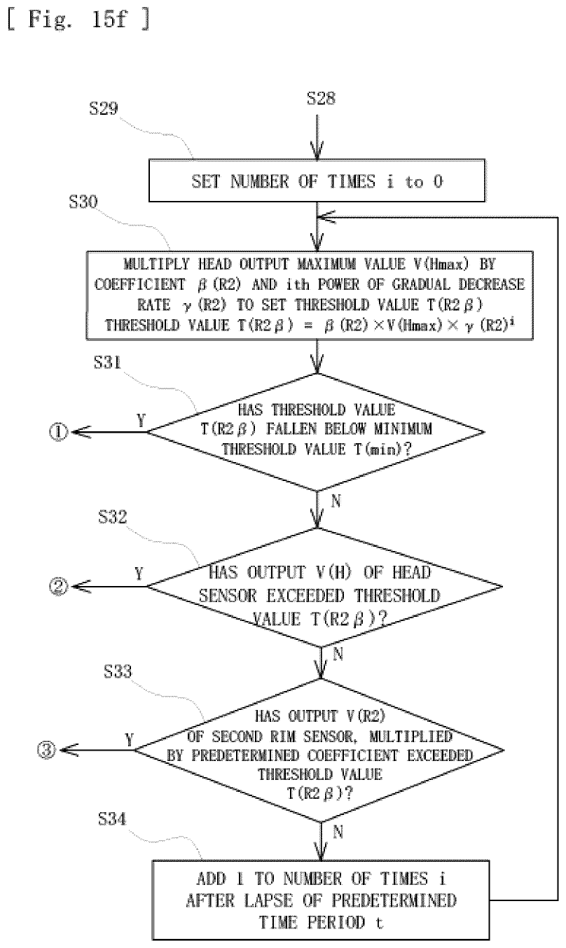

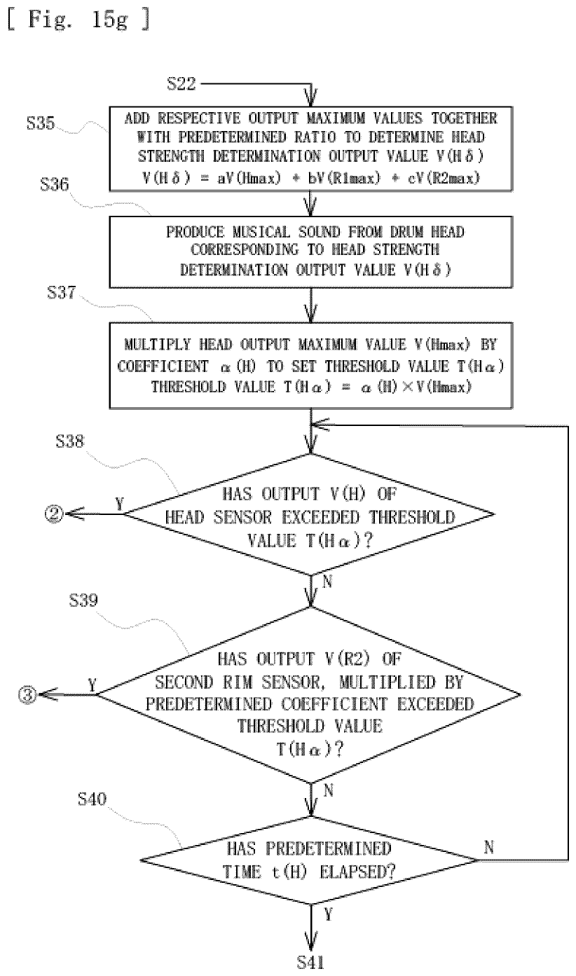

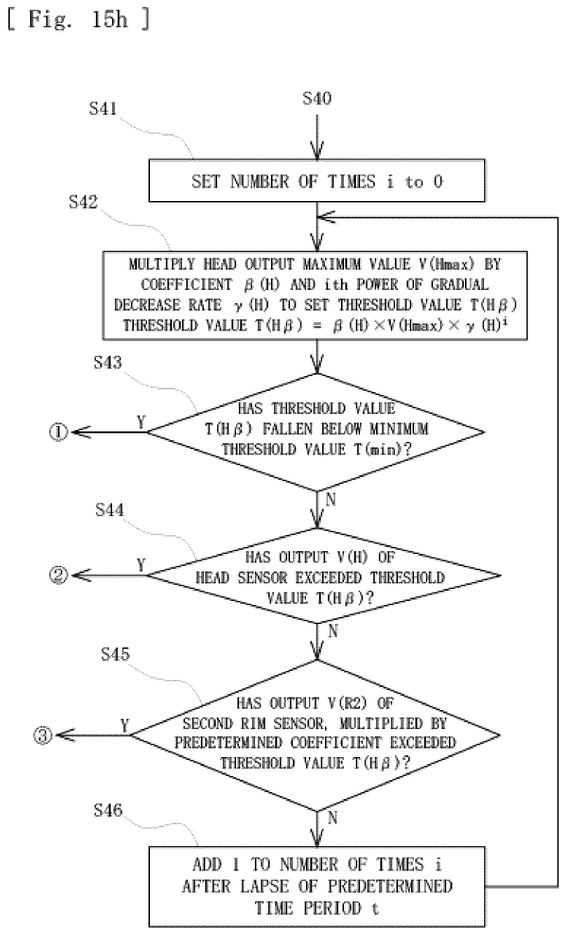

Next, the control of the sound source part 28 according to the present embodiment will be described based on FIGS. 15a to 15h.

First, in S1, it is determined whether the output V(H) (detection signal) of each head sensor 25 has exceeded a minimum threshold value T(Hmin), and when the determination is affirmative, in S2, the output maximum value V(Hmax) of the head sensor 25 in a predetermined time period is obtained. Subsequently, in S3, the output maximum value V(R1max) of the first rim sensor 26 in the predetermined time period is obtained, and in S4, the output maximum value V(R2max) of the second rim sensor 27 in the predetermined time period is obtained.

Subsequently, in S5, it is determined whether the ratio of the output maximum value V(R1max) of the first rim sensor 26 in the predetermined time period to the output maximum value V(Hmax) of the head sensor 25 is higher than or equal to a predetermined proportion. When the determination is affirmative, the flow proceeds to S6, and the respective output maximum values V(Hmax), V(R1max) and V(R2max) are added together with a predetermined ratio to determine a first rim strength determination output value V(R1δ), otherwise, the flow proceeds to S22, and the subsequent control is performed.

In S7, a musical sound (a musical sound when the first rim 18 is hit) from the drum first rim corresponding to the first rim strength determination output value V(R1δ) is produced by the output 15. Subsequently, in S8, the head output maximum value V(Hmax) is multiplied by the coefficient α(R1) to set the threshold value T(R1α) (constant threshold value), then it is determined in S9 whether the output V(H) of the head sensor 25 has exceeded the threshold value T(R1α) (constant threshold value).

In S9, when the output V(H) of the head sensor 25 is determined to have exceeded the threshold value T(R1α) (constant threshold value), the flow returns to S2 and the subsequent control is repeated. When the output V(H) of the head sensor 25 is determined not to have exceeded the threshold value T(R1α) (constant threshold value), it is determined in S10 whether the output V(R2) of the second rim sensor 27, which has been multiplied by a predetermined coefficient has exceeded the threshold value T(R1α).

In S10, when the output V(R2) of the second rim sensor 27 multiplied by a predetermined coefficient is determined to have exceeded the threshold value T(R1α), the flow returns to S19 and the subsequent control is performed. When the output V(R2) of the second rim sensor 27 multiplied by a predetermined coefficient is determined not to have exceeded the threshold value T(R1α), it is determined in S11 whether a predetermined time t(R1) has elapsed. In S11, when the predetermined time t(R1) is determined not to have elapsed, the flow returns to S9 and the subsequent control is repeated. When the predetermined time t(R1) is determined to have elapsed, in S12, the number of times i is set to 0, and in S13, the output maximum value V(Hmax) is multiplied by a coefficient β(R1) and ith power of a gradual decrease rate γ(R1) to set a threshold value T(R1β) (gradual decrease line).

Subsequently, in S14, it is determined whether the threshold value T(R1β) (gradual decrease line) has fallen below the minimum threshold value T(min). When the threshold value T(R1β) is determined to have fallen below the minimum threshold value T(min), the flow returns to S1 and the subsequent control is repeated. When the threshold value T(R1β) is determined not to have fallen below the minimum threshold value T(min), it is determined in S15 whether the output V(H) of the head sensor 25 has exceeded the threshold value T(R1β) (gradual decrease line).

In S15, when the output V(H) of the head sensor 25 is determined to have exceeded the threshold value T(R1β) (gradual decrease line), the flow returns to S2 and the subsequent control is repeated. When the output V(H) of the head sensor 25 is determined not to have exceeded the threshold value T(R1β) (gradual decrease line), it is determined in S16 whether the output V(R2) of the second rim sensor 27 multiplied by a predetermined coefficient has exceeded the threshold value T(R1β) (gradual decrease line).

In S16, when the output V(R2) of the second rim sensor 27 multiplied by a predetermined coefficient is determined to have exceeded the threshold value T(R1β) (gradual decrease line), the flow proceeds to S19 and the subsequent control is performed. When the output V(R2) of the second rim sensor 27 multiplied by a predetermined coefficient is determined not to have exceeded the threshold value T(R1β) (gradual decrease line), in S17, after lapse of the predetermined time period, 1 is added to the number of times i, then in S13, the threshold value T(R1β) (gradual decrease line) is set again, and subsequently, S14 to S17 are repeated.

Meanwhile, in S1, when the output V(H) (detection signal) of the head sensor 25 is determined not to have exceeded the minimum threshold value T(min), it is determined in S18 whether the output V(R2) (detection signal) of the second rim sensor 27 has exceeded a minimum threshold value T(R2min). When the determination is affirmative, in S19, the output maximum value V(Hmax) of the head sensor 25 in the predetermined time period is obtained. In S18, when the output V(R2) (detection signal) of the second rim sensor 27 is determined not to have exceeded the minimum threshold value T(min), the flow returns to S1 and the subsequent control is repeated.

When S19 is completed, in S20, the output maximum value V(R1max) of the first rim sensor 26 in the predetermined time period is obtained, and in S21, the output maximum value V(R2max) of the second rim sensor 27 in the predetermined time period is obtained. Subsequently, the flow proceeds to S23, and the respective output maximum values V(Hmax), V(R1max) and V(R2max) are added together with a predetermined ratio to determine a second rim strength determination output value V(R2δ).

Subsequently, in S24, a musical sound (a musical sound when the second rim 19 is hit) from the drum second rim corresponding to the second rim strength determination output value V(R2δ) is produced by the output 15. Subsequently, in S25, the head output maximum value V(Hmax) is multiplied by the coefficient α(R2) to set the threshold value T(R2α) (constant threshold value), then it is determined in S26 whether the output V(H) of the head sensor 25 has exceeded the threshold value T(R2α) (constant threshold value).

In S26, when the output V(H) of the head sensor 25 is determined to have exceeded the threshold value T(R2α) (constant threshold value), the flow returns to S2 and the subsequent control is repeated. When the output V(H) of the head sensor 25 is determined not to have exceeded the threshold value T(R2α) (constant threshold value), it is determined in S27 whether the output V(R2) of the second rim sensor 27 multiplied by a predetermined coefficient has exceeded the threshold value T(R2α).

In S27, when the output V(R2) of the second rim sensor 27 multiplied by a predetermined coefficient is determined to have exceeded the threshold value T(R2α), the flow returns to S19 and the subsequent control is performed. When the output V(R2) of the second rim sensor 27 multiplied by a predetermined coefficient is determined not to have exceeded the threshold value T(R2α), it is determined in S28 whether the predetermined time t(R2) has elapsed. In S28, when the predetermined time t(R2) is determined not to have elapsed, the flow returns to S26 and the subsequent control is repeated. When the predetermined time t(R2) is determined to have elapsed, in S29, the number of times i is set to 0, and in S30, the head output maximum value V(Hmax) is multiplied by a coefficient β(R2) and ith power of the gradual decrease rate γ(R2) to set a threshold value T(R2β) (gradual decrease line).

Subsequently, in S31, it is determined whether the threshold value T(R2β) (gradual decrease line) has fallen below the minimum threshold value T(min). When the threshold value T(R2β) is determined to have fallen below the minimum threshold value T(min), the flow returns to S1 and the subsequent control is repeated. When the threshold value T(R2β) is determined not to have fallen below the minimum threshold value T(min), it is determined in S32 whether the output V(H) of the head sensor 25 has exceeded the threshold value T(R2β) (gradual decrease line).

In S32, when the output V(H) of the head sensor 25 is determined to have exceeded the threshold value T(R2β) (gradual decrease line), the flow returns to S2 and the subsequent control is repeated. When the output V(H) of the head sensor 25 is determined not to have exceeded the threshold value T(R2β) (gradual decrease line), it is determined in S33 whether the output V(R2) of the second rim sensor 27 multiplied by a predetermined coefficient has exceeded the threshold value T(R2β) (gradual decrease line).

In S33, when the output V(R2) of the second rim sensor 27 multiplied by a predetermined coefficient is determined to have exceeded the threshold value T(R2β) (gradual decrease line), the flow returns to S19 and the subsequent control is performed. When the output V(R2) of the second rim sensor 27 multiplied by a predetermined coefficient is determined not to have exceeded the threshold value T(R2β) (gradual decrease line), in S34, after lapse of the predetermined time period, 1 is added to the number of times i, then in S30, the threshold value T(R2β) (gradual decrease line) is set again, and subsequently, S31 to S34 are repeated.

Meanwhile, in S22, when the ratio of the output maximum value V(R2max) of the second rim sensor 27 to the output maximum value V(Hmax) of the head sensor 25 is determined not to be higher than or equal to a predetermined proportion, the flow returns to S35, and the respective output maximum values V(Hmax), V(R1max) and V(R2max) are added together with a predetermined ratio to determine a head strength determination output value V(Hδ).

Subsequently, in S36, a musical sound (a musical sound when the head 17 is hit) from the drum head corresponding to the head strength determination output value V(Hδ) is produced by the output 15. Subsequently, in S37, the head output maximum value V(Hmax) is multiplied by the coefficient α(H) to set the threshold value T(Hα) (constant threshold value), then it is determined in S38 whether the output V(H) of the head sensor 25 has exceeded the threshold value T(Hα) (constant threshold value).

In S38, when the output V(H) of the head sensor 25 is determined to have exceeded the threshold value T(Hα) (constant threshold value), the flow returns to S2 and the subsequent control is repeated. When the output V(H) of the head sensor 25 is determined not to have exceeded the threshold value T(Hα) (constant threshold value), it is determined in S39 whether the output V(R2) of the second rim sensor 27 multiplied by a predetermined coefficient has exceeded the threshold value T(Hα).

In S39, when the output V(R2) of the second rim sensor 27 multiplied by a predetermined coefficient is determined to have exceeded the threshold value T(Hα), the flow returns to S19 and the subsequent control is performed. When the output V(R2) of the second rim sensor 27 multiplied by a predetermined coefficient is determined not to have exceeded the threshold value T(Hα), it is determined in S40 whether the predetermined time t(H) has elapsed. In S40, when the predetermined time t(H) is determined not to have elapsed, the flow returns to S38 and the subsequent control is repeated. When the predetermined time t(H) is determined to have elapsed, in S41, the number of times i is set to 0, and in S42, the output maximum value V(Hmax) is multiplied by a coefficient β(H) and ith power of the gradual decrease rate γ(H) to set a threshold value T(Hβ) (gradual decrease line).

Subsequently, in S43, it is determined whether the threshold value T(Hβ) (gradual decrease line) has fallen below the minimum threshold value T(min). When the threshold value T(Hβ) is determined to have fallen below the minimum threshold value T(min), the flow returns to S1 and the subsequent control is repeated. When the threshold value T(Hβ) is determined not to have fallen below the minimum threshold value T(min), it is determined in S44 whether the output V(H) of the head sensor 25 has exceeded the threshold value T(Hβ) (gradual decrease line).

In S44, when the output V(H) of the head sensor 25 is determined to have exceeded the threshold value T(Hβ) (gradual decrease line), the flow returns to S2 and the subsequent control is repeated. When the output V(H) of the head sensor 25 is determined not to have exceeded the threshold value T(Hβ) (gradual decrease line), it is determined in S45 whether the output V(R2) of the second rim sensor 27 multiplied by a predetermined coefficient has exceeded the threshold value T(Hβ) (gradual decrease line).

In S45, when the output V(R2) of the second rim sensor 27 multiplied by a predetermined coefficient is determined to have exceeded the threshold value T(Hβ) (gradual decrease line), the flow returns to S19 and the subsequent control is performed. When the output V(R2) of the second rim sensor 27 multiplied by a predetermined coefficient is determined not to have exceeded the threshold value T(Hβ) (gradual decrease line), in S46, after lapse of the predetermined time period, 1 is added to the number of times i, then in S42, the threshold value T(Hβ) (gradual decrease line) is set again, and subsequently, S43 to S46 are repeated.

In the electronic percussion instrument (the electronic cymbal and the electronic drum) according to the present embodiment, the sound source part (10, 28) includes: the hit position identification part (12, 30) configured to identify the hit position which has been hit based on the detection signal output from the hit detection part; the threshold value setting part (13, 31) configured to set a threshold value according to the hit position identified by the hit position identification part (12, 30); and the musical sound production part (14, 32) configured to produce and output a predetermined musical sound based on a detection signal which has exceeded the threshold value set by the threshold value setting part (13, 31). The threshold value set by the threshold value setting part (13, 31) forms a gradual decrease line which gradually decreases with a lapse of time. The gradual decrease line is set individually for each hit position identified by the hit position identification part (12, 30). Thus, a threshold value can be set in consideration of the vibration characteristics at each hit position, and even when the hit positions are consecutively hit, a musical sound according to each hit can be reliably produced and output.

The sound source part (10, 28), according to the present embodiment, after the detection signal output from the hit detection part exceeds a minimum threshold value, produces a musical sound corresponding to a maximum detection signal output in an interval until a predetermined time period elapses since the exceeding. Thus, an appropriate musical sound according to a hitting force can be output while preventing false detection of a hit.

Furthermore, the threshold value setting part (13, 31) according to the present embodiment, obtains a coefficient according to the hit position identified by the hit position identification part (12, 30). The threshold value setting part (13, 31) sets a constant threshold value obtained by multiplying the value of a maximum detection signal by a coefficient for a predetermined time, and sets a gradual decrease line subsequent to the constant threshold value. Thus, a relatively larger threshold value can be set in a predetermined time before the gradual decrease line is set, and false detection of a hit can be reliably prevented without affecting the detection of consecutive hits. In particular, a predetermined time is set individually for each hit position identified by the hit position identification part (12, 30). Thus, in the predetermined time before a gradual decrease line is set, a threshold value can be appropriately set according to the hit position, and false detection of a hit can be prevented more reliably.

Furthermore, the threshold value setting part (13, 31), according to the present embodiment, obtains a gradual decrease rate according to the hit position identified by the hit position identification part (12, 30). The threshold value setting part (13, 31) sets a gradual decrease line by consecutively multiplying the gradual decrease rate by the value obtained by multiplying the value of a maximum detection signal by a coefficient. Thus, an appropriate gradual decrease line according to the maximum detection signal can be set individually for each hit, and false detection of a hit can be prevented while maintaining the performance of detection of consecutive hits.

In addition, the threshold value setting part (13, 31), according to another embodiment, pre-stores multiple gradual decrease lines corresponding to hit positions. The threshold value setting part (13, 31) selects and sets a gradual decrease line according to the hit position identified by the hit position identification part (12, 30). Thus, a gradual decrease line can be set more smoothly, as compared to when a gradual decrease line is sequentially calculated.

However, according to the first embodiment, the body 1 includes an electronic cymbal including the bow part Fa, the edge part Fc or the cup part Fb as the hit positions. Thus, a threshold value can be set in consideration of the vibration characteristics at each hit position in the electronic cymbal. According to the second embodiment, the body 16 includes an electronic drum including the head 17, the first rim 18 or the second rim 19 as the hit positions. Thus, a threshold value can be set in consideration of the vibration characteristics at each hit position in the electronic drum.

Although the present embodiments have been described so far, the present disclosure is not limited. For example, the threshold value set by the threshold value setting part may form a curved shape, a linear shape or a discontinuous shape provided that the threshold value forms a gradual decrease line which gradually decreases with a lapse of time, and a gradual decrease line is set individually for each hit position identified by the hit position identification part. With the threshold value according to the present embodiment, a gradual decrease line is set subsequent to a constant threshold value, but only a gradual decrease line may be set.

The electronic cymbal may only have the bow part Fa and the edge part Fc as the hit positions, or the electronic cymbal may only have the bow part Fa and the cup part Fb as the hit positions. Furthermore, the electronic drum may only have the head 17 and the first rim 18 as the hit positions, or the electronic drum may only have the head 17 and the second rim 19 as the hit positions. In the present embodiment, the disclosure is applied to an electronic cymbal and an electronic drum, but may be applied to another electronic percussion instrument.

The disclosure is applicable to an electronic percussion instrument having a different external shape or another additional function provided that the threshold value set by the threshold value setting part forms a gradual decrease line which gradually decreases with a lapse of time, and a gradual decrease line is set individually for each hit position identified by the hit position identification part.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electronic percussion instrument comprising:
a body having a plurality of hit positions to be hit by a player;
a hit detection part is mounted on the body and configured to detect a hit at the hit positions and output a predetermined detection signal;
a sound source part produces and outputs a predetermined musical sound based on the detection signal output from the hit detection part,
the sound source part including:
a hit position identification part identifying one of the hit positions based on the detection signal output from the hit detection part;
a threshold value setting part sets a threshold value according to the hit position identified by the hit position identification part;
a musical sound production part produces and outputs a predetermined musical sound based on the detection signal which has exceeded the threshold value set by the threshold value setting part,
wherein the threshold value set by the threshold value setting part forms a gradual decrease line that gradually decreases with a lapse of time, and
the gradual decrease line is set individually for the hit position identified by the hit position identification part.

2. The electronic percussion instrument according to claim 1, wherein the sound source part, after the detection signal output from the hit detection part exceeds a minimum of the threshold value, produces a musical sound corresponding to a maximum of the detection signal output in an interval until a predetermined time period elapses since the exceeding.

3. The electronic percussion instrument according to claim 2, wherein the threshold value setting part obtains a coefficient according to the hit position identified by the hit position identification part, set a constant threshold value obtained by multiplying a value of the maximum of the detection signal by the coefficient for a predetermined time, and sets the gradual decrease line subsequent to the constant threshold value.

4. The electronic percussion instrument according to claim 3, wherein the predetermined time is set individually for the hit position identified by the hit position identification part.

5. The electronic percussion instrument according to claim 3, wherein the threshold value setting part obtains a gradual decrease rate according to the hit position identified by the hit position identification part, and sets the gradual decrease line by consecutively multiplying the gradual decrease rate by a value obtained by multiplying the value of the maximum of the detection signal by the coefficient.

6. The electronic percussion instrument according to claim 2, wherein the threshold value setting part pre-stores multiple gradual decrease lines corresponding to the hit positions, and selects and sets one of the gradual decrease lines according to the hit position identified by the hit position identification part.

7. The electronic percussion instrument according to claim 1, wherein the body is comprised of an electronic cymbal having a bow part, an edge part or a cup part as the hit positions.

8. The electronic percussion instrument according to claim 1, wherein the body is comprised of an electronic drum having a head, a first rim or a second rim as the hit positions.
